(19) United States
(12) Patent Application Publication
(10) Pub. No.: US 2013/0021176 A1
(43) Pub. Date: Jan. 24, 2013

(54) Method of Handling Incoming Telephone Calls and Text Messages and Systems Therefor

(71) Applicants: Jason Tu, Mission Viejo, CA (US); Kristina Donofrio, Simi Valley, CA (US); David Hoard, Escondido, CA (US)

(72) Inventors: Jason Tu, Mission Viejo, CA (US); Kristina Donofrio, Simi Valley, CA (US); David Hoard, Escondido, CA (US)

(73) Assignee: Belkin Internaitonal, Inc., Playa Vista, CA (US)

(21) Appl. No.: 13/185,280

(22) Filed: Jul. 18, 2011

(51) Int. Cl. G08G 1/123; H04B 1/38

(52) U.S. Cl. 340/994; 455/567; 455/412.2

(57) ABSTRACT

Some embodiments concern a method of processing an incoming telephone call. The method can include: receiving notification of the incoming telephone call using a cellular telephone, the incoming telephone call is from a first caller; determining a speed of a vehicle, the cellular telephone is located in the vehicle; facilitating answering of the incoming telephone call by a user if the speed of the vehicle is below a predetermined speed; and automatically answering the incoming telephone call if the speed of the vehicle is above the predetermined speed. Automatically answering the incoming telephone call can include playing a predetermined message to the first caller; receiving a response to the predetermined message; and notifying the user of the response to the predetermined message. Other embodiments are disclosed.

### FIELD OF THE INVENTION

This invention relates to electrical accessories for electrical devices, particularly electrical devices including media players and/or cellular telephones. More specifically, the invention relates to an electrical accessory configured to at least partially control one or more electrical devices, to transmit data signals received from one or more electrical devices to a speaker system, and/or to provide data signals to the one or more electrical device.

### DESCRIPTION OF THE BACKGROUND

Numerous types of electrical devices are portable, such as, for example, cellular (or mobile) telephones, laptop computers, audio playback devices, AM (amplitude modulated) and FM (frequency modulated) radios, CD (compact disk) players, and media (e.g., MP3 (MPEG Audio Layer-3)) players. The terms “electrical device” and “media device” are broadly understood to include electrical devices of all types and designs (e.g., media players, telephones, audio-visual media players, and devices incorporating media players, telephones, and/or audio-visual devices).

Many electrical devices rely on batteries for their portability and typically utilize headsets, earphones, or a small built-in speaker for user listening. Battery life is sometimes a problem. After a few hours of usage, most of these electrical devices need an alternate power source, need to be charged, or need to have their batteries replaced. Another limitation is that these electrical devices typically play sounds for only one listener at a time (e.g., via headset or earphones). Even if the electrical device is equipped with a speaker, the device's small size and light-weight design limit the size of the speaker, which tends to make the speaker inadequate for transmitting music to a group of people, e.g., in a vehicle.

Electrical accessories that attempt to overcome these limitations are available, for example, to supply power to the electrical devices for operation and/or charging and to transmit the audio signal to another device (e.g., an FM transmission system). An FM transmission system when used in conjunction with an electrical device allows the user to play music files stored on the electrical device through an FM audio system so that one can listen and allow others to listen to the stored music. However, current FM transmission systems are often unstable and provide weak FM signals, which can result in a loss of the signal or a constant static hiss in the background. In such known FM transmission systems, the FM signal strength is sometimes weakened or lost because of inefficient antenna design (e.g., concerning its size, shape, and/or location).

Another common problem with electrical devices is that these electrical accessories are designed to work with only a limited set of the capabilities of the electrical devices. For example, many electrical accessories can receive audio (e.g., audio files) from the electrical devices, but are not integrated with the other features (e.g., telephonic features) of the electrical device. Furthermore, another common problem with electric accessories is that the electrical accessories are configured to work with only a single electrical device at any time. In many cases, a user will have two or more electrical devices he or she wants to use with the electrical accessory, but the electrical accessory is designed to work with only a single electrical device at any time.

Accordingly, a need exists for an apparatus or accessory that allows a user to utilize the full breadth of capabilities of two or more electrical devices including media players, telephones, and/or audio-visual devices.

### BRIEF DESCRIPTION OF THE DRAWINGS

To facilitate further description of the embodiments, the following drawings are provided in which:

FIG. 1 illustrates an overview of a system for transmitting data signals between at least two electrical devices, a receiving device, and an electrical accessory, according to a first embodiment;

FIG. 2 illustrates a block diagram of one of the electrical devices of FIG. 1, according to the first embodiment;

FIG. 3 illustrates a block view of the electrical accessory of FIG. 1, according to the first embodiment;

FIG. 4 illustrates a flow chart for an embodiment of a method of using at least two electrical devices and the electrical accessory of FIG. 1, according to the first embodiment;

FIG. 5 illustrates a flow chart for an embodiment of an activity of handling a request to place a telephone call, according to the first embodiment;

FIG. 6 illustrates a flow chart for an embodiment of an activity of handling an end of the telephone call, according to the first embodiment;

FIG. 7 illustrates a flow chart for an embodiment of an activity of reconciling a contact list of a dialer application with a contact list of a first mobile media device, according to the first embodiment;

FIG. 8 illustrates a flow chart for an embodiment of a method of processing an incoming telephone call from a first caller, according to a second embodiment;

FIG. 9 illustrates a flow chart for an embodiment of an activity of automatically answering the incoming telephone call, according to the second embodiment;

FIG. 10 illustrates a flow chart for an embodiment of a method of processing an incoming text message from a first sender of text messages, according to a third embodiment;

FIG. 11 illustrates a flow chart for an embodiment of a method of notifying one or more people of an expected time of arrival of a user, according to a fourth embodiment;

FIG. 12 illustrates a flow chart for an exemplary embodiment of an activity of executing one or more rules related to a current route, according to the fourth embodiment; and

FIG. 13 illustrates a flow chart for an embodiment of a method of advising a user of an electrical accessory of one or more information items, according to a fifth embodiment.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically and/or otherwise. Two or more electrical elements may be electrically coupled but not be mechanically or otherwise coupled; two or more mechanical elements may be mechanically coupled, but not be electrically or otherwise coupled; two or more electrical elements may be mechanically coupled, but not be electrically or otherwise coupled. Coupling may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types.

The absence of the word “removably,” “removable,” and the like near the word “coupled,” and the like does not mean that the coupling, etc. in question is or is not removable.

### DETAILED DESCRIPTION OF EXAMPLES OF EMBODIMENTS

Some embodiments concern a method of processing an incoming telephone call. The method can include: receiving notification of the incoming telephone call using a cellular telephone, the incoming telephone call is from a first caller, and the cellular telephone is located in the vehicle; determining a speed of a vehicle; if the speed of the vehicle is below a predetermined speed, facilitating answering of the incoming telephone call by a user, the user is located in the vehicle; and if the speed of the vehicle is above the predetermined speed, automatically answering the incoming telephone call, automatically answering the incoming telephone call include: transmitting a predetermined message for the first caller; receiving a response to the predetermined message; and notifying the user of the response to the predetermined message.

Other embodiments can concern a method of processing two or more incoming text messages. The method can include: receiving a first incoming text message of the two or more incoming text messages from a first sender; determining a speed of a vehicle; if the speed of the vehicle is below a predetermined speed, facilitating notification of a user of the first incoming text message of the two or more incoming text messages, the user is located in the vehicle; if the speed of the vehicle is above the predetermined speed, facilitating sending an automatic reply to the first incoming text message of the two or more incoming text messages; after facilitating sending the automatic reply, receiving a second incoming text message of the two or more incoming text messages; if the second incoming text message of the two or more incoming text messages is received from the first sender and the second incoming text message of the two or more incoming text messages includes a predetermined bypass indicator, facilitating notification of the user of the first incoming text message of the two or more incoming text messages; and if the user has not previously been notified of the first incoming text message of the two or more incoming text messages, facilitating notification of the user of the first incoming text message of the two or more incoming text messages when the speed of the vehicle is below the predetermined speed.

Still other embodiments can concern a method of notifying one or more people of an expected time of arrival of a user at one or more destination locations. The method can include; storing one or more first routes between one or more departure locations and the one or more destination locations; storing one or more rules related to the one or more first routes; determining if a current route is one of the one or more first routes; if the current route is the one of the one or more first routes, executing the one or more rules related to the one of the one or more first routes. Executing the one or more rules can include: determining a current location of a GPS receiver; determining an amount of time to travel from the current location to a first destination location of the one or more destination locations; and communicating information regarding the amount of time to at least one predetermined person. The current route is between a first departure location of the one or more departure locations and the first destination location of the one or more destination locations. Additional embodiments concern a method of advising a user of an electrical accessory of one or more information items. The method can include: establishing a first communication path between a first mobile media device and an second mobile media device, the first electrical accessory comprises a cellular telephone; requesting a first one or the one or more information items from the first mobile media device; receiving the first one of the one or more information item in the second mobile media device; converting the first one of the one or more information into a first audio; and transmitting the first audio to one or more speakers.

Further embodiments can a method of using a first mobile media device, a second mobile media device, and an electrical accessory. The first mobile media device can include a cellular telephone and a second mobile media device configured to couple to the electrical accessory. The method can include: facilitating installation of a dialer application in the second mobile media device; receiving in the dialer application a request to place a first telephone call to a first contact; determining a first telephone number of the first contact using a stored list of contact information; receiving in the electrical accessory the request to place the first telephone call from the dialer application; communicating the request to place the first telephone call from the electrical accessory to the first mobile media device; receiving in the dialer application a request to end the first telephone call; receiving in the electrical accessory the request to end the first telephone call from the dialer application; communicating the request to end the first telephone call from the electrical accessory to the first mobile media device; requesting a first list of contact information from the first mobile media device; receiving the first list of contact information from the first mobile media device; communicating the first list of contact information from the electrical accessory to the second mobile media device; and creating an updated list of contact information using the stored list of contact information and the first list of contact information.

In some examples, the method can further include receiving in the dialer application a request to place a second telephone call to a second contact; determining a second telephone number of the second contact using the updated list of contact information; receiving in the electrical accessory the request to place the second telephone call from the dialer accessory; and communicating the request to place the second telephone call from the electrical accessory to the first mobile media device.

In the same or different examples, wirelessly coupling the electrical accessory to the first mobile media device; and establishing a communication path between the electrical accessory and the second mobile media device using a physical coupling between the electrical accessory and the second mobile media device. In various examples, the method can further include communicating incoming audio for the first telephone call to one or more speakers of a vehicle and/or receiving outgoing audio for the first telephone call using the electrical accessory and communicating the outgoing audio to the first mobile media device.

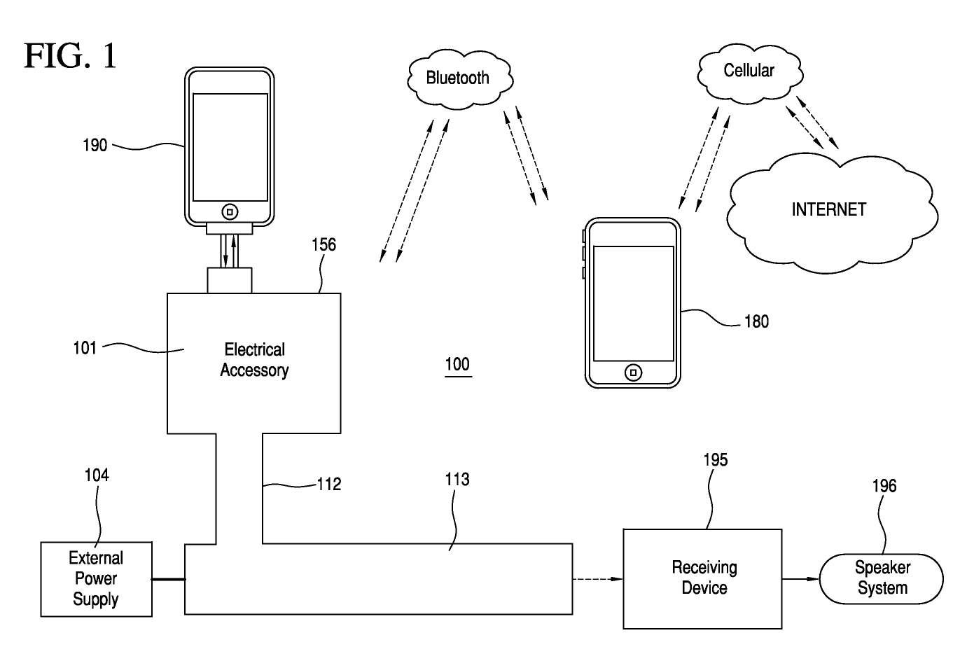

FIG. 1 illustrates an overview of a system 100 for transmitting data signals between electrical devices 190 and 180, a receiving device 195, and an electrical accessory 101, according to a first embodiment. System 100 is merely exemplary and is not limited to the embodiments presented herein. System 100 can be employed in many different embodiments or examples not specifically depicted or described herein.

As illustrated in FIG. 1, in some examples, electrical accessory 101 can be configured to transmit one or more data signals from electrical device 190 and/or electrical device 180 to receiving device 195. Receiving device 195 can broadcast the data signals using speakers 196.

In some embodiments, electrical accessory 101 can wirelessly transmit the data signals to receiving device 195. In one example, the data signals can be wirelessly transmitted over a radio frequency. In another example, the data signals can be wirelessly transmitted using a Bluetooth™ connection between electrical accessory 101 and receiving device 195. In other embodiments, electrical accessory 101 can transmit the data signals to receiving device 195 over a wired connection.

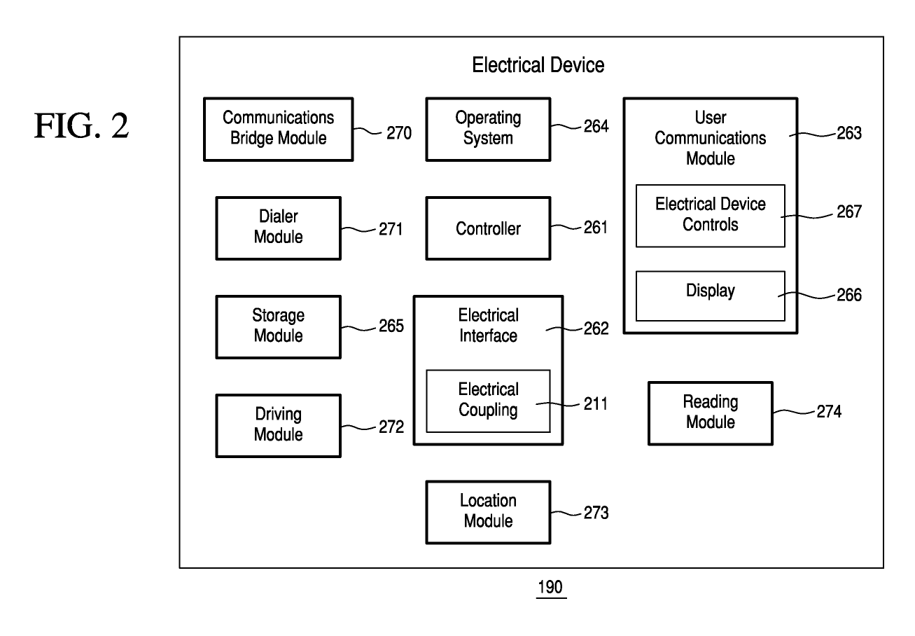

In some examples, electrical accessory 101 can also be coupled to electrical device 190 using an electrical coupling 211 (FIG. 2). For example, electrical device 190 can be an iPod® device, iPad® device, or an iTouch® device, and electrical device 190 can be coupled to electrical accessory 101 using a thirty-pin dock connector. Electrical accessory 101 can receive data signals from electrical device 190 through electrical coupling 211 and transmit the data signals to receiving device 195.

In various examples, electrical device 180 and electrical accessory 101 can be in communication using a wireless signal. In this example, electrical accessory 101 can receive data signals (e.g., music, data signals, or audio signals from a telephone call) over the wireless signal and transmit the data signals to receiving device 195 and/or electrical device 180. For example, electrical device 180 can include a cellular telephone (e.g. a Blackberry® device or an iPhone® device) and can be wirelessly coupled to electrical accessory 101 using a Bluetooth connection.

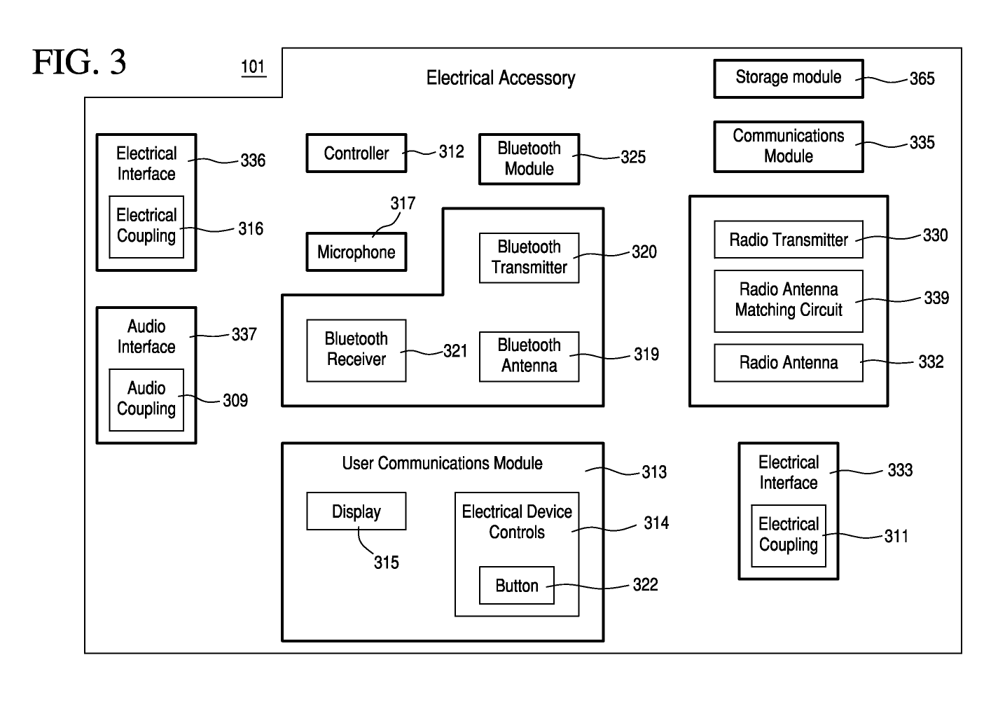

In some examples, electrical device 180 includes a cellular telephone and can send and receive telephone calls, data signals, and/or text messages. The data signals transmitted from electrical accessory 101 to receiving device 195 can be the incoming audio from the telephone call, and the data signals provided to electrical device 180 from electrical accessory 101 can be the outgoing audio. In these examples, electrical accessory 101 and receiving device 195 can function as a speaker system (i.e., a speaker phone) for electrical device 180 with the speakers, for example, being a vehicle speaker system. Microphone 317 (FIG. 3) can receive sounds (e.g., a user's voice) and convert the sounds into data signals that are provided to electrical device 180.

In another example, data can be transferred from electrical device 180 to electrical device 190 via electrical accessory 101. In some embodiments, data signals can be transferred from electrical device 180 to electrical accessory 101. Electrical accessory 101 can retransmit the data signals to electrical device 190. For example, electrical device 180 can receive a text message using its cellular telephone. Electrical device 180 can communicate the text message to electrical accessory 101, which can communicate the text message to electrical device 190. Similarly, audio (e.g., a telephone call), video, or other information can be transferred from electrical device 180 to electrical device 190 via electrical accessory 101.

In still further embodiments, data signals can be transferred from electrical device 190 to electrical device 180 via electrical accessory 101. For example, data signals can be transferred from electrical device 190 to electrical accessory 101, and electrical accessory 101 can retransmit the data signals to electrical device 180.

In the same or different embodiments, electrical accessory 101 can also at least partially control electrical devices 190 and/or 180 using electrical device controls 314 (FIG. 3). In some examples, electrical device controls 314 can include at least button 322 (FIG. 3) that allows the user to answer and/or end a telephone call, and/or to play, pause, fast forward and/or rewind audio being played on electrical device 190 or 180.

In some embodiments, electrical devices 190 and 180 can be electrical devices configured to produce and receive electrical signals. For example, electrical devices 190 and/or 180 can be a cellular (or mobile) phone, a laptop computer, an audio playback device, a portable AM (amplitude modulated) and FM (frequency modulated) radio, a satellite radio, a portable CD (compact disk) player, a data storage device, an audio player, an audio-visual player, and/or a portable media (e.g., MP3) player. For example, electrical devices 190 and/or electrical device 180 can be an electrical device manufactured by Sony Corp., Philips Corp., Audiovox Corp., Microsoft Corp. (e.g., the Zune® MP3 player), Research in Motion Limited (e.g., the Blackberry® device), Palm, Inc. (e.g., the Palm® device), or Apple Computer, Inc. (e.g., the iPod® MP3 player, the iTouch® device, iPad® device, and/or the iPhone® device).

Receiving device 195 can be any electrical device that includes a receiver configured to receive radio frequency (or other high frequency) signals. In some embodiments, receiving device 195 can be an FM and/or AM radio. Receiving device 195 can include or be coupled to one or more speakers 196. For example, if receiving device 195 is a car radio, the car radio can be electrically coupled to the car's speaker system.

A “Bluetooth wireless protocol,” as used herein, is a standard and is a communications protocol for exchanging electrical signals over short distances. In some examples, the Bluetooth wireless protocol refers to the Bluetooth 3.0+HS (High Speed) specification, adopted by the Bluetooth SIG (Special Interest Group) on Apr. 29, 2009. In other examples, the Bluetooth wireless protocol refers to other versions of the Bluetooth wireless protocol, for example, Bluetooth 2.1+EDR (Enhanced Data Rate) adopted by the Bluetooth SIG on July 26, 2007. The Bluetooth 3.0+HS specification and the Bluetooth 2.1+EDR specification are incorporated herein by reference. The Bluetooth wireless protocol can also refer to a Bluetooth specification adopted subsequent to the Bluetooth 3.0+HS specification. In some examples, electrical devices communicate using the Bluetooth wireless protocol over a 2.4 GHz (gigahertz) band. In various embodiments, transmitters and receivers that use the Bluetooth wireless protocol can be referred to as Bluetooth transmitters and Bluetooth receivers, respectively.

In some examples, the set of radio frequencies used by electrical accessory 101 to transmit the data signals to receiving device 195 can include the full FM band. In the United States (US), the FM band includes the frequencies or channels between 88.1 MHz (megahertz) and 108 MHz. In Japan, the FM band includes frequencies between 76 MHz and 90 MHz. In Europe, the FM band includes frequencies between 87.6 MHz and 107.9 MHz. In other countries, the full FM band can span other ranges of radio frequencies. In further embodiments, the set of radio frequencies includes other carrier frequency sets or bands (e.g., the AM (amplitude modulated) band, the VHF (very high frequency) band, and/or the UHF (ultra high frequency) band).

FIG. 2 illustrates a block diagram of electrical device 190, according to the first embodiment. Electrical device 190 is merely exemplary and is not limited to the embodiments presented herein. Electrical device 190 can be employed in many different embodiments or examples not specifically depicted or described herein.

In some examples, electrical device 190 can include: (a) a controller 261; (b) an electrical interface 262; (c) a user communications module 263; (d) an operating system 264; (e) storage module 265; (f) communications bridge module 270 configured to be stored in storage module 265 and performed using a controller 261; (g) controller 261; (h) a dialer module 271 configured to be stored in storage module 265 and performed using controller 261; (i) a driving module 272 configured to be stored in storage module 265 and performed using controller 261; (j) a location module 273 configured to be stored in storage module 265 and performed using controller 261; and (k) a reading module 274 configured to be stored in storage module 265 and performed using controller 261.

In other examples, one or more of dialer module 271, driving module 272, location module 273, or reading module 274 can be stored in storage module 365 (FIG. 3) and performed using controller 312. In still further examples, one or more of dialer module 271, driving module 272, location module 273, or reading module 274 can be stored in a storage module of electrical device 180 (FIG. 1) and performed using a controller of electrical device 180 (FIG. 1).

In some embodiments, electrical interface 262 can include electrical coupling 211 and electrical circuitry (if any) needed to use electrical coupling 211. Electrical coupling 211 can be configured to mechanically and electrically couple to electrical coupling 311 of electrical accessory 101. Electrical interface 262 can be further configured to receive data signals from electrical accessory 101 and provide the data signals to communications bridge module 270. For example, electrical coupling 211 can be a thirty-pin female connector configured to mechanically and electrically couple to a thirty-pin male connector on electrical accessory 101.

User communications module 263 of electrical device 190 can include: (a) electrical device controls 267; and (b) at least one display 266. Electrical device controls 267 are configured to at least partially control electrical device 190, electrical accessory 101, and/or electrical device 180. Display 315 (FIG. 3) can be used to display information about a transmission frequency. In the examples shown in FIG. 1, electrical device 190 include a button, which is part of electrical device controls 267, and a touch screen, which is part of electrical device controls 267, and display 266.

In various embodiments, operating system 264 can be one or more software programs that manage the hardware and software resources of a computer and/or a computer network. Operating system 264 performs basic tasks such as, for example, controlling and allocating memory, prioritizing the processing of instructions, controlling input and output devices, facilitating networking, and managing files. Common operating systems for a mobile device include the iPhone® operating system by Apple Inc. of Cupertino, Calif., the Blackberry® operating system by Research In Motion (RIM) of Waterloo, Ontario, Canada, the Palm® operating system by Palm, Inc. of Sunnyvale, Calif., the Android operating system developed by the Open Handset Alliance, the Windows Mobile operating system by Microsoft Corp. of Redmond, Wash., or a Symbian operating system by Nokia Corp. of Espoo, Finland.

In some examples, storage module 265 can include memory and/or a hard drive. The memory can include both read only memory (ROM) and random access memory (RAM). Non-volatile portions of memory or the ROM can be encoded with a boot code sequence suitable for restoring electrical device 190 to a functional state after a system reset. In addition, memory can include microcode such as a Basic Input-Output System (BIOS).

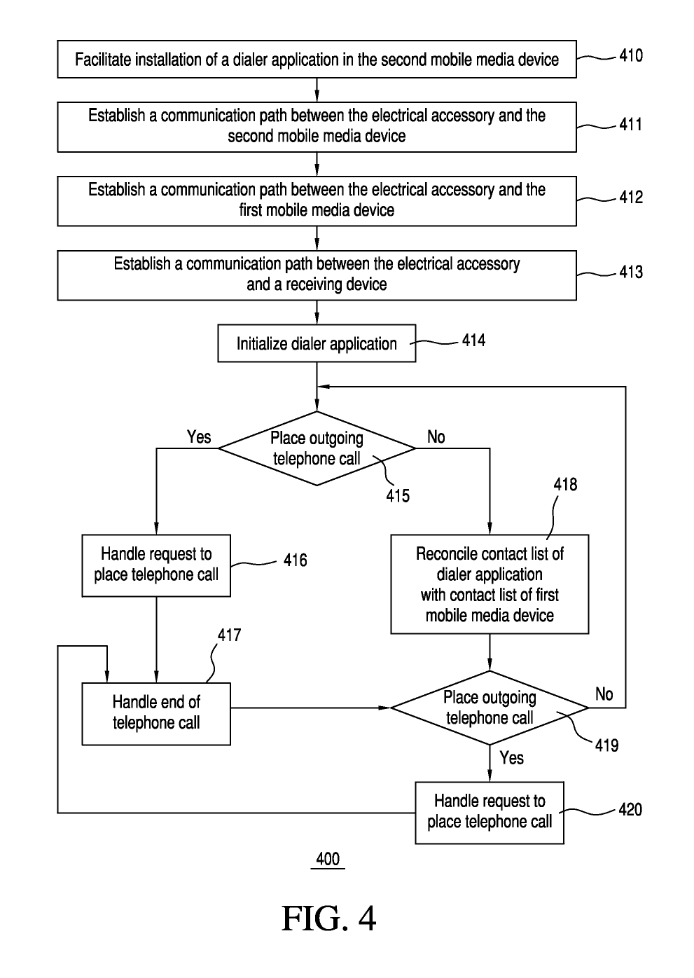

When electrical device 190 is running, program instructions stored in storage module 265 are executed by controller 261. A portion of the program instructions, stored on these devices, can be suitable for carrying out method 400, 800, 1000. 1100 and/or 1300 as described with respect to FIGS. 4-13 below.

FIG. 3 illustrates a block view of electrical accessory 101, according to the first embodiment. Electrical accessory 101 is merely exemplary and is not limited to the embodiments presented herein. Electrical accessory 101 can be employed in many different embodiments or examples not specifically depicted or described herein.

Referring to FIGS. 1 and 3, an apparatus or electrical accessory 101 can include: (a) a cradle or holder 156 configured to hold or couple to electrical device 190 and/or 180; (b) a connector 112; (c) a power acquisition unit 113 configured to receive electrical power from an external power source 104; (d) at least one electrical interface 333 and 336; (e) a controller 312; (f) a user communications module 313; (g) at least one microphone 317; (h) communications module 335; (i) Bluetooth module 325; (j) at least one audio interface 337; and (k) storage module 365.

In some embodiments, electrical interface 333 can include an electrical coupling 311 and electrical circuitry (if any) needed to use electrical coupling 211. Electrical interface 333 can be electrically coupled to power acquisition unit 113, user communications module 313, communications module 335, and controller 312. Electrical coupling 311 can be configured to mechanically and electrically couple to an electrical coupling 211 of electrical device 190 and/or am electrical coupling of electrical device 180. Electrical interface 333 can be further configured to receive data signals from the electrical device and provide the data signals to communications module 335. For example, electrical coupling 311 can be a thirty-pin male connector configured to mechanically and electrically couple to a thirty-pin female connector (not shown) on electrical device 190 (e.g., a thirty-pin dock connector on the iPhone® device, iTouch® device, and some iPod® devices).

In some examples, electrical accessory 101 can send instructions to electrical device 190 using electrical interface 333. For example, controller 312 can send instructions to electrical device 190 to start, pause, or stop providing data signals through electrical coupling 211.

Bluetooth module 325 can be configured to transmit data signals to electrical device 180 and receive data signals from electrical device 180, without being physically coupled to electrical device 180. In some examples, Bluetooth module 325 can include: (a) at least one Bluetooth transmitter 320; (b) at least one Bluetooth receiver 321; and (c) a Bluetooth antenna 319.

Bluetooth transmitter 320 can be electrically coupled to Bluetooth antenna 319 and be configured to transmit data signals using a Bluetooth wireless protocol (i.e., Bluetooth transmitter 320 can be a Bluetooth transmitter). Bluetooth transmitter 320 can be electrically coupled to microphone 317 and audio interface 337 and configured to transmit data signals (e.g., audio) to electrical device 190. In some examples, microphone 317 can convert sounds into data signals, and Bluetooth transmitter 320 can transmit the data signals to electrical device 180.

Bluetooth receiver 321 can be electrically coupled to Bluetooth antenna 319 and configured to receive data signals using a Bluetooth wireless protocol (i.e., Bluetooth receiver 321 can be a Bluetooth receiver). Bluetooth receiver 321 can be electrically coupled to radio transmitter 330 of communications module 335. In some examples, Bluetooth receiver 321 can receive the data signals (e.g., audio) from electrical device 180 and provide the data signals to radio transmitter 330. In some examples, the data signals include voice signals from a telephone call. In various examples, a Bluetooth transmitter can include Bluetooth transmitter 320 and Bluetooth receiver 321. In other examples, a Bluetooth receiver 321 and a Bluetooth transmitter 320 separate from Bluetooth receiver 321 can be used.

In other embodiments, Bluetooth transmitter 320 and Bluetooth receiver 321 can communicate using protocols other than the Bluetooth wireless protocol. For example, Bluetooth transmitter 320 and Bluetooth receiver 321 can communicate using WI-FI (wireless fidelity) IEEE (Institute of Electrical and Electronics Engineers) 802.11 wireless protocol.

Communications module 335 can be electrically coupled to Bluetooth module 325. Communications module 335 can be configured to transmit the data signals received from electrical devices 190 and/or 180 to receiving device 195 (FIG. 1) (e.g., an external speaker system). In various examples, communications module 335 can transmit the data signals over an FM radio frequency. Communications module 335 can include at least one radio transceiver or radio transmitter 330, radio antenna matching circuit 339, and radio antenna 332, and communicates module 335 can be further coupled to Bluetooth module 325. Radio transmitter 330 can be coupled to a radio antenna matching circuit 339. Radio antenna matching circuit 339 can be coupled to a radio antenna 332. In some examples, electrical accessory 101 can include a mechanism that allows a user to select a radio frequency over which the data signals are transmitted by radio transmitter 330. In the same or different examples, electrical accessory 101 can manually, automatically, or semi-automatically select the radio frequency.

In some examples, communications module 335 is configured to transmit data signals from electrical device 190 to receiving device 195 (using radio transmitter 330 and radio antenna 332) until communications module 335 is instructed to begin transmitting data signals from electrical device 180 to receiving device 195.

Radio transmitter 330 can be configured to transmit data signals over the radio frequency using radio antenna 332. Radio transmitter 330 can be configured to transmit data signals (e.g., audio) to external speakers 196 coupled to receiving device 195. In many examples, Radio transmitter 330 includes an FM and/or AM radio frequency transmitter. Radio transmitter 330 can be coupled to radio antenna 332 through radio antenna matching circuit 339. In some examples, transmitter can be configured to transmit the data signals over one or more frequencies in the set of radio frequencies.

To comply with FCC (Federal Communications Commission) requirements, the output of radio transmitter 330 (electrical signals) is coupled to an attenuation circuit (not shown). The amount of attenuation that is needed to comply with FCC requirements is dictated by the output of the particular transmitter, the quality and type of antenna that is being utilized, and the environment in which the transmitter is being used. Consequently, the specific design of the attenuation circuit is a matter of design choice depending upon the needs of the particular application. For some types of electrical signals to be transmitted by radio transmitter 330, an attenuation circuit will not be needed. In some embodiments, the attenuation circuit can be a portion of radio antenna matching circuit 339. In the same or different examples, Bluetooth transmitter 320 can also be coupled to an attenuation circuit (not shown). In some embodiments, electrical accessory 101 can be coupled to an external antenna (not shown) through an external antenna matching circuit (not shown) in addition to or instead of Bluetooth antenna 319 and/or radio antenna 332.

Microphone 317 can be configured to receive sounds and convert the sounds into data signals. Microphone 317 can be electrically coupled to Bluetooth module 325 and configured to provide data signals to Bluetooth module 325.

In some examples, microphone 317 can be located at holder 156 (FIG. 1). In other examples, microphone 317 is located at electrical power acquisition unit 113 (FIG. 1). In many embodiments, microphone 317 is located at holder 156 (FIG. 1), instead of electrical power acquisition unit 113 (FIG. 1) because locating microphone 317 at holder 156 (FIG. 1) can provide better pick-up of voices and other audio.

User communications module 313 can include: (a) first control or electrical device controls 314; and (b) at least one display 315. Electrical device controls 314 can include button 322 and the electrical circuitry to implement the electrical device controls. Electrical device controls 314 are configured to at least partially control electrical device 190 (FIG. 1) and/or electrical device 180 (FIG. 1). For example, button 322 can be used to begin and end a telephone call when electrical device 190 or 180 (FIG. 1) includes a cellular telephone. Button 322 can also be used to play, pause, fast forward, and rewind when electrical device 190 is configured to play music or other audio. In some examples, electrical device controls 313 can also include one or more buttons to allow a user to select the radio frequency over which radio transmitter 330 will transmit the data signals.

The term “button” should be broadly understood to refer to any type of mechanism (with or without moving parts) whereby the user can input to electrical accessory 101 his or her data signals (for example, selection of a frequency), e.g., a mechanical pushbutton, an electrostatic pushbutton, an electrostatic array, or any other input device of any type.

Display 315 can be used to display information about a transmission frequency. For example, display 315 can display the carrier frequency at which radio transmitter 330 is transmitting data signals in the format “XXX.X.” In many examples, display 315 is an LCD (liquid crystal display). In other examples, display 315 can be a touch screen.

In some embodiments, audio interface 337 can include an audio coupling 309 and electrical circuitry (if any) needed to use audio coupling 309. In some examples, audio coupling 309 can be a female TRS (Tip, Ring, Sleeve) connector (e.g., a 2.5 millimeter (mm) or 3.5 mm female TRS connector), XLR jacks, RCA (Radio Corporation of America) plugs, ¼ inch stereo jack, and/or banana jacks. In some examples, audio output received from electrical device 190 (FIG. 1) through electrical coupling 316 can be provided to radio transmitter 330.

In some examples, audio coupling 309 can be configured to electrically and mechanically couple to receiving device 195 (FIG. 1) to provide the data signals from electrical device 190 or 180 (FIG. 1) to receiving device 195 (FIG. 1). In some examples, when audio coupling 309 is providing data signals to receiving device 195 , radio transmitter 330 is not transmitting the data signals. In other examples, electrical accessory 101 (FIG. 1) does not include radio transmitter 330, and audio coupling 309 can be the only mechanism for communicating data signals to receiving device 195 (FIG. 1). In some examples, audio coupling 309 can be considered part of communications module 335.

In other examples, audio coupling 309 can be configured to couple to an external microphone or other external audio input devices to receive data signals. In some examples, the external audio input device can be used to provide data signals to electrical device 180 (FIG. 1) instead of or in addition to microphone 317.

In some embodiments, electrical interface 336 can include an electrical coupling 316 and electrical circuitry (if any) needed to use electrical coupling 316. Electrical interface 336 can be electrically coupled to power acquisition unit 113 (FIG. 1) and configured to provide electrical power to other electrical devices. In some examples, electrical coupling 316 can be a female universal serial bus connector.

Controller 312 can be electrically coupled to and at least partially control the operation of communications module 335, Bluetooth module 325, microphone 317, electrical interfaces 333 and 336, audio interface 337, and user communications module 313. For example, controller 312 can be a microprocessor, such as part no. C8051T611-GM manufactured by Silicon Laboratories, Inc. of Austin, Tex., or a microcontroller, such as part no. ST72F264G2H1 or STM8L151K4U6, manufactured by STMicroelectronics of Switzerland.

For example, controller 312 can be configured such that controller 312 can instruct electrical device 190 (FIG. 1) to stop providing data signals when Bluetooth receiver 321 begins to receive data signals from electrical device 180 (FIG. 1), and/or can instruct radio transmitter 330 to stop transmitting the data signals from electrical device 190 (FIG. 1), and/or can instruct electrical interface 333 to stop receiving the data signals from electrical device 190 (FIG. 1). Controller 312 can also be configured to instruct electrical device 190 (FIG. 1) to start providing data signals after Bluetooth receiver 321 stops receiving data signals from electrical device 180 (FIG. 1), and/or to instruction radio transmitter 330 to start transmitting the data signals from electrical device 180 (FIG. 1) and/or to instruct electrical interface 333 to start receiving the data signals from electrical device 190 (FIG. 1). In many embodiments, controller 312 can start, stop, and/or pause the data signals by sending the instructions to electrical device 190 (FIG. 1) via electrical coupling 211 (FIG. 2).

In various embodiments, controller 312 can be further configured such that controller 312 can instruct radio transmitter 330 to stop providing data signals to receiving device 195 when audio interface 337 is electrically coupled to receiving device 195 (FIG. 1). In this situation, the data signals are provided to receiving device 195 (FIG. 1) via audio interface 337 (i.e., a wired connection) instead of via a wireless connection. Storage module 365 can be similar or the same as storage module 265 of FIG. 2.

Furthermore, Bluetooth receiver 321 can be configured to receive a signal indicating that electrical device 180 (FIG. 1) is receiving a telephone call. When Bluetooth receiver 321 receives this signal, controller 312 can instruct electrical device 190 (FIG. 1) to automatically stop providing data signals. In some examples, controller 312 can automatically send a signal to electrical device 180 (FIG. 1) instructing electrical device 180 (FIG. 1) to answer the telephone call.

In other examples, radio transmitter 330 can transmit the signal (e.g., a ringing sound) to receiving device 195 (FIG. 1), and controller 312 can wait for the user to press button 322 to instruct electrical device 180 (FIG. 1) to answer the telephone call. If the user presses button 322, controller 312 sends a signal to electrical device 180 (FIG. 1) instructing electrical device 180 (FIG. 1) to answer the telephone call, and radio transmitter 330 begins transmitting data signals from electrical device 180 (FIG. 1) to receiving device 195 (FIG. 1). If the user presses button 322 again, controller 312 can send a signal to electrical device 180 (FIG. 1) instructing electrical device 180 (FIG. 1) to end the telephone call. After the user presses button 322 to end the call or Bluetooth receiver 321 stops receiving data signals from electrical device 180, controller 312 can automatically instruct electrical device 190 to begin sending data signals again (e.g., restart the music).

If the user does not press button 322 again, controller 312 can instruct electrical device 190 (FIG. 1) to automatically begin sending data signals again after Bluetooth receiver 321 stops receiving the indications from electrical device 180.

Similarly, if electrical device 190 includes a cellular telephone and receives a telephone call, controller 312 can automatically instruct electrical device 190 (FIG. 1) to answer the telephone call or wait for the user to press button 322 to instruct electrical device 180 (FIG. 1) to answer the telephone call.

Holder 156 (FIG. 1) can be configured to mechanically couple to and hold electrical device 190. Connector 112 (FIG. 1) can be a semi-rigid elongated portion configured to allow a position of holder 156 (FIG. 1) to be semi-permanently adjusted relative to a position of the power acquisition unit 113 (FIG. 1). In some examples, connector 112 (FIG. 1) can include a gooseneck, which can be compliant (or obedient) flexible tubing, and is preferably metallic or metal covered with, e.g., plastic or elastic material on its outside.

In some examples, power acquisition unit 113 (FIG. 1) is configured to couple to a cigarette lighter of a vehicle using electrical coupling 316. That is, electrical coupling 316 can include a cigarette lighter adapter.

FIG. 4 illustrates a flow chart for an embodiment of a method 400 of using a first mobile media device, a second mobile media device, and an electrical accessory, according to the first embodiment. In some examples, method 400 can provide a method for two mobile media devices to communicate and perform synchronizing or other functions that would not be capable without use of the electrical accessory. Method 400 can allow a user to use the capabilities and/or features of the second mobile media device to enhance and provide additional capabilities and/or features of the first mobile media device that would be otherwise unavailable to the user of the first mobile media device. Method 400 can also be considered to provide a method for which these features of the second mobile media device can be combined with the cellular phone capabilities of the first mobile media device to create a system with capabilities beyond the individual capabilities of each of the mobile media devices.

Method 400 is merely exemplary and is not limited to the embodiments presented herein. Method 400 can be employed in many different embodiments or examples not specifically depicted or described herein. In some embodiments, the activities, the procedures, and/or the processes of method 400 can be performed in the order presented. In other embodiments, the activities, the procedures, and/or the processes of the method 400 can be performed in any other suitable order. In still other embodiments, one or more of the activities, the procedures, and/or the processes in method 400 can be combined or skipped.

In some examples, the first mobile media device can be similar to or the same as mobile media device 180 of FIG. 1. The second mobile media device can be the same as or similar to electrical device 190 of FIGS. 1 and 2. The electrical accessory can be similar to or the same as electrical accessory 101 of FIGS. 1 and 3. In other examples, the second mobile media device and the electrical accessory can be combined into a single electrical device. In still other examples, the second mobile media device can perform all the activities performed by the electrical accessory in method 400 or vice versa.

Referring to FIG. 4, method 400 includes an activity 410 of facilitating installation of a dialer module in the second mobile media device. In some examples, the dialer module can be similar to or the same as dialer module 271 of FIG. 2. In some examples, a user can install the dialer module in the second mobile media device. In different examples, a manufacturer or a third party could install the dialer module in the second mobile media device.

In some embodiments, facilitating installation of the dialer module can involve facilitating the loading of the dialer module into the memory of the second mobile media device. For example, facilitating installation of the dialer module could be accomplished by publishing or arranging for the publication of the dialer module on one or more websites or the like, where a user can download or otherwise acquire the dialer module. In some examples, the download could occur over the Internet or a cellular telephone network. In another example, facilitating installation of the dialer module could be accomplished by arranging for the dialer module to transfer into the memory of the second mobile media device before or after the purchase of the second mobile media device by the user.

Method 400 in FIG. 4 continues with an activity 411 of establishing a communication path between the electrical accessory and the second mobile media device. In some embodiments, the communication path can be established using a physical coupling between the electrical accessory and the second mobile media device. For example, a communication path can be established between electrical device 190 (FIG. 1) and electrical accessory 101 (FIG. 1) by coupling an electrical coupling of holder 156 of electrical accessory 101 (FIG. 1) to electrical coupling 211 (FIG. 2) of electrical device 190 (FIG. 1). In some examples, after the electrical coupling of holder 156 (FIG. 1) is coupled to electrical coupling 211 (FIG. 2), a communications initialization routine can be performed as part of establishing the communications path.

In other examples, the communication path can be established by wirelessly coupling electrical device 190 (FIG. 1) to electrical accessory 101 (FIG. 1). For example, a Bluetooth® connection can be established between electrical device 190 (FIG. 1) and electrical accessory 101 (FIG. 1).

Subsequently, method 400 of FIG. 4 includes an activity 412 of establishing a communication path between the electrical accessory and the first mobile media device. In various embodiments, the communication path can be established by wirelessly coupling mobile media device 180 (FIG. 1) to electrical accessory 101 (FIG. 1). For example, a Bluetooth® connection can be established between mobile media device 180 (FIG. 1) and electrical accessory 101 (FIG. 1). In some examples, after establishing the wireless connection, a communications initialization routine can be performed as part of establishing the communications path. In other embodiments, the communication path can be established using a physical coupling between the electrical accessory and the first mobile media device.

Method 400 in FIG. 4 continues with an activity 413 of establishing a communication path between the electrical accessory and a receiving device. In various embodiments, a communication path can be established between radio transmitter 330 (FIG. 3) in electrical accessory 101 (FIG. 1) and a receiver in receiving device 195 (FIG. 1). In many embodiments, radio transmitter 330 (FIG. 3) can be an FM transmitter, and receiving device 195 (FIG. 1) can include a FM receiver. The communication path in these embodiments can be established by tuning radio transmitter 330 (FIG. 3) and the receiver in receiving device 195 (FIG. 1) to the same frequency (e.g., 103.5 MHz (megahertz)).

Subsequently, method 400 of FIG. 4 includes an activity 414 of initializing the dialer module. In some examples, initializing can involve starting the dialer module and/or the dialer module communicating with the operating system and/or other elements of electrical device 190 (FIG. 1). In some examples, as part of the initialization, the dialer module can check to see if a list of contacts is stored in the memory of electrical device 190 (FIG. 1) and when the list of contacts was last updated.

Referring again to FIG. 4, method 400 of FIG. 4 includes an activity 415 of determining if the user wants to place an outgoing telephone call. If the user wants to place an outgoing telephone call, the next activity is activity 416. If the user does not want to place an outgoing telephone call, the next activity is activity 418.

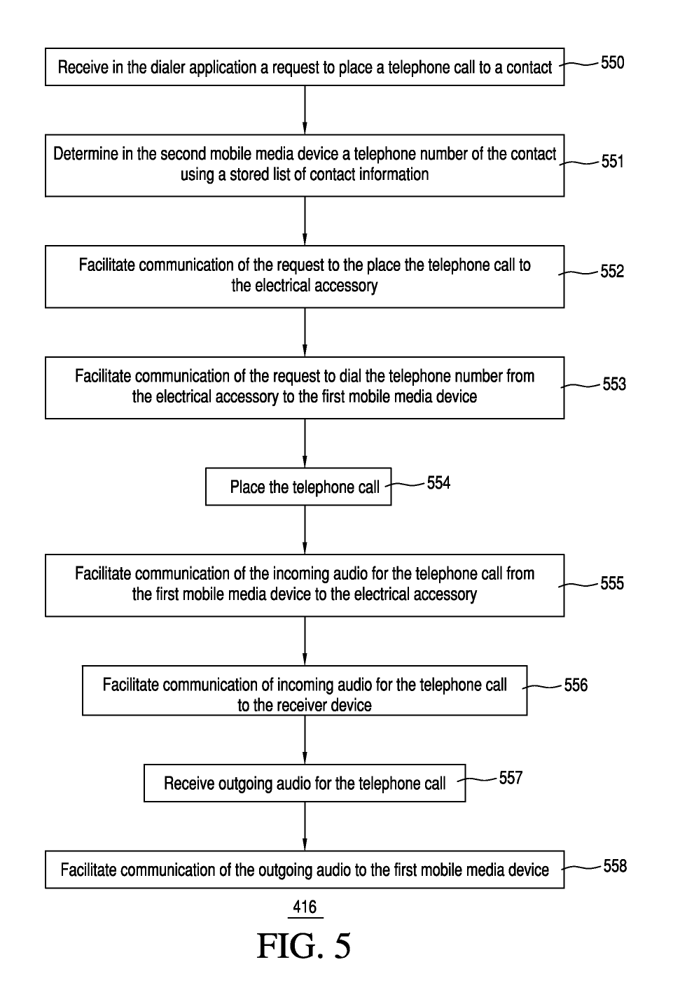

In activity 416, a request to place a telephone call is handled. FIG. 5 illustrates a flow chart for an embodiment of activity 416 of handling the request to place a telephone call, according to the first embodiment.

Activity 416 in FIG. 5 includes a procedure 550 of receiving in the dialer module of the second mobile media device a request to place a first telephone call to a first contact. For example, a user of electrical device 190 (FIG. 1) can enter select dialer module 271 (FIG. 2) using electrical device controls 267 (FIG. 2). Dialer module 271 (FIG. 2) can populate display 266 (FIG. 2) with a version of the contact list stored in storage module 265 (FIG. 2). The user can select one of the contacts, and controller 261 (FIG. 2) can communicate the selected contact to dialer module 271 (FIG. 2). A contact can include a name of a person, business, or entity and one or more telephone numbers associated with the person, business, or entity.

Subsequently, activity 416 of FIG. 5 includes a procedure 551 of determining in the second mobile media device a first telephone number of the first contact using a stored list of contact information. In some embodiments, dialer module 271 (FIG. 2) can determine the telephone number associated with the contact. For example, dialer module 271 can access the list of contact information stored in storage module 265.

Next, activity 416 of FIG. 5 includes a procedure 552 of facilitating communication of the request to place the first telephone call to the electrical accessory. The request to call the telephone number of the contact can be communicated from the second mobile media device to the electrical accessory. In some embodiments, dialer module 271 (FIG. 2) can facilitate the communication of the telephone number by communicating the request to controller 261 (FIG. 2) or electrical interface 262 (FIG. 2) to communicate the request to electrical accessory 101 (FIG. 1).

Activity 416 in FIG. 5 continues with a procedure 553 of facilitating communication of the request to dial the first telephone number from the electrical accessory to the first mobile media device. In many embodiments, the request can be communicated from the electrical accessory to the first mobile media device using the Bluetooth® connection between the first mobile media device and the electrical accessory. For example, electrical accessory 101 (FIG. 1) can communicate the request to call the telephone number of the selected contact to electrical device 180 (FIG. 1). For example, controller 312 (FIG. 3) can facilitate communication of the request by instructing Bluetooth transmitter 320 (FIG. 3) to transmit to electrical device 180. In some examples, Bluetooth transmitter 320 (FIG. 3) can facilitate the communication of the request by transmitting the request to electrical device 180 (FIG. 1).

Activity 416 of FIG. 5 can include a procedure 554 of placing the telephone call. In some examples, electrical device 180 (FIG. 1) can include a cellular telephone that can be used to place the telephone call to the telephone number of the contact in electrical device 190 (FIG. 1).

Next, activity 416 of FIG. 5 includes a procedure 555 of facilitating communication of the incoming audio for the telephone call from the first mobile media device to the electrical accessory. In some examples, the incoming audio can be communicated from the first mobile media device to the electrical accessory using the Bluetooth® connection between the first mobile media device and the electrical accessory. In some examples, Bluetooth receiver 321 (FIG. 3) can facilitate the communication of the incoming audio by receiving the incoming audio from electrical device 180 (FIG. 1).

Subsequently, activity 416 of FIG. 5 includes a procedure 556 of facilitating communication of incoming audio for the first telephone call to one or more speakers of a vehicle. In some examples, electrical accessory 101 (FIG. 1) can communicate the incoming audio to receiving device 195 (FIG. 1). Receiving device 195 (FIG. 1) can broadcast the audio using speakers 196 (FIG. 1). In some examples, controller 312 (FIG. 3) can facilitate the communication by instructing radio transmitter 330 (FIG. 3) to transmit the audio. Communications module 335 (FIG. 3) and/or radio transmitter 330 (FIG. 3) can also be considered facilitating the communication of the incoming audio by transmitting the incoming audio.

Next, activity 416 of FIG. 5 includes a procedure 557 of receiving outgoing audio for the telephone call using the electrical accessory. In some examples, a user can speak into microphone 317 (FIG. 3), and this audio is the outgoing audio for the telephone call.

Activity 416 in FIG. 5 continues with a procedure 558 of facilitating communication of the outgoing audio to the first mobile media device. In many embodiments, the outgoing audio can be communicated from the electrical accessory to the first mobile media device using the Bluetooth® connection between the first mobile media device and the electrical accessory. For example, electrical accessory 101 (FIG. 1) can communicate the outgoing audio to electrical device 180 (FIG. 1). For example, controller 312 (FIG. 3) can facilitate communication of the outgoing audio by instructing Bluetooth transmitter 320 (FIG. 3) to transmit to electrical device 180 (FIG. 1). In some examples, Bluetooth transmitter 320 (FIG. 3) can facilitate the communication of the outgoing audio by transmitting the outgoing audio to electrical device 180 (FIG. 1). After procedure 558, activity 416 is complete.

Referring again to FIG. 4, method 400 in FIG. 4 continues with an activity 417 of handling an end of the telephone call. In some situations, the receiver of the telephone call can end the telephone call. In these instances, the first mobile media device can communicate that the telephone call has been ended to the electrical accessory, which can communicate that the telephone call has ended to the second mobile media device and the dialer module.

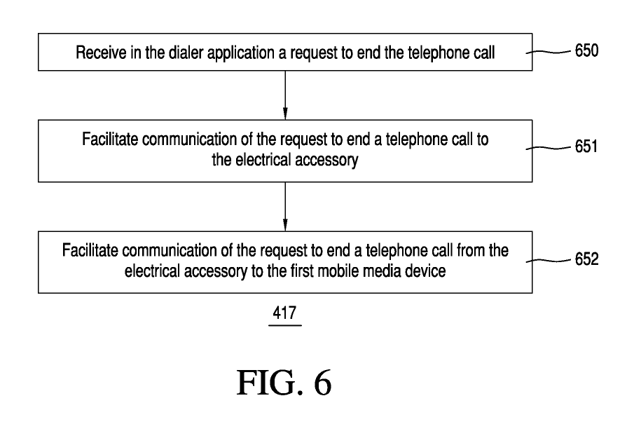

If the user of the second mobile media device ends the telephone call, FIG. 6 illustrates a flow chart for an embodiment of activity 417 of handling an end of the telephone call, according to the first embodiment. Activity 417 in FIG. 6 includes an activity 650 of receiving in the dialer module a request to end the telephone call. In some examples, referring to FIGS. 1-3, a user interface screen of dialer module 271 is shown on display 266 of electrical device 190. The user can use electrical device controls 267 to end the telephone call.

Referring again to FIG. 4, subsequently, activity 417 of FIG. 6 includes a procedure 651 of facilitating communication of the request to end a telephone call to the electrical accessory. In some examples, facilitating communication of the request to end a telephone call from the dialer module to the electrical accessory can be similar to procedure 552 of FIG. 5 of facilitating communication of the request to place the telephone call to the electrical accessory

Next, activity 417 of FIG. 6 includes a procedure 652 of facilitating communication of the request to end a telephone call from the electrical accessory to the first mobile media device. In some examples, facilitating communication of the request to end a telephone call from the electrical accessory to the first mobile media device can be similar to procedure 553 of FIG. 5 of facilitating communication of the request to dial the telephone number from the electrical accessory to the first mobile media device. After procedure 652, activity 417 is complete. In some examples, the next activity is activity 419. In other examples, the next activity is activity 418.

In other examples, the other party to the telephone call can end the telephone call. In these examples, the telephone call will end without any actions by system 100 (FIG. 1).

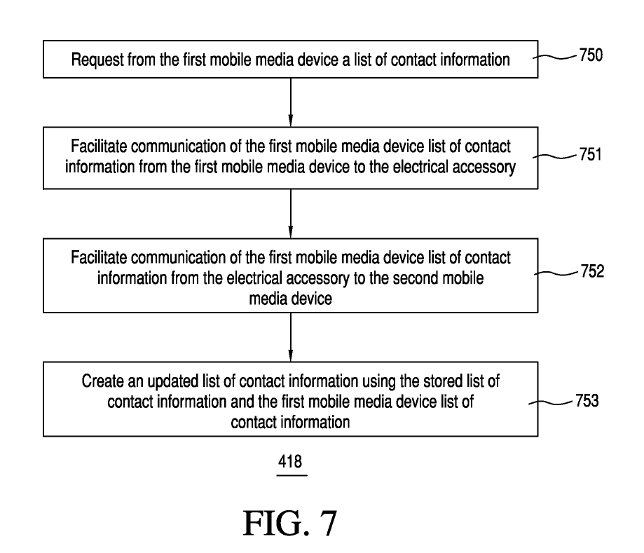

Referring again to FIG. 4, method 400 of FIG. 4 includes an activity 418 of reconciling the contact list of the dialer module with a contact list of the first mobile media device. In some examples, activity 418 can be before, after, or concurrent with activities 416 and 417. FIG. 7 illustrates a flow chart for an embodiment of activity 418 of reconciling the contact list of the dialer module with the contact list of the first mobile media device, according to the first embodiment.

Referring to FIG. 7, activity 418 in FIG. 7 includes a procedure 750 of requesting a first mobile media device list of contact information from the first mobile media device. In some examples, both the first mobile media device and the second mobile media device can include a list of contacts. In procedure 750, dialer module 271 (FIG. 2) of mobile media device 190 (FIG. 2) can send a request to electrical device 180 (FIG. 1) to provide its list of contacts to dialer module 271 (FIG. 2). In some embodiments, dialer module 271 (FIG. 2) can communicate the request to electrical device 180 (FIG. 1) via electrical apparatus 101 (FIG. 1).

Subsequently, activity 418 of FIG. 7 includes a procedure 751 of facilitating communication of the first mobile media device list of contact information from the first mobile media device to the electrical accessory. In some examples, transmitting the contact list from the first mobile media device to the electrical accessory can be similar to procedure 555 of FIG. 5.

Next, activity 418 of FIG. 7 includes a procedure 752 of facilitating communication of the first mobile media device list of contact information from the electrical accessory to the second mobile media device. In some examples, facilitating communication of the first mobile media device list of contact information from the electrical accessory to the second mobile media device can be similar to procedure 556 of FIG. 5.

Activity 418 in FIG. 7 continues with a procedure 753 of creating an updated list of contact information using the stored list of contact information in the second mobile media device and the first mobile media device list of contact information. In some examples, dialer module 271 (FIG. 2) can create an updated list of contact information by synchronizing the two lists of contact information. For example, any contact on the list from the first mobile media device but not on the stored list of contact information can be added to the stored list of contact information. Also, if the stored list of contact information and the first mobile media device list of contact information include different information for a specific contact, the dialer module can make the list consistent based on user preferences and/or predefined rules. After procedure 753, activity 418 is complete.

Referring again to FIG. 4, method 400 of FIG. 4 includes an activity 419 of determining if the user wants to place an outgoing telephone call. If the user wants to place another outgoing telephone call, the next activity is activity 420.

Method 400 in FIG. 4 continues with an activity 420 of handling a request to place a telephone call. In many examples, activity 420 can be similar to or the same as activity 415 except that the updated contact list is used instead of the original contact list stored in the second mobile media device. After activity 420, the next activity is activity 417.

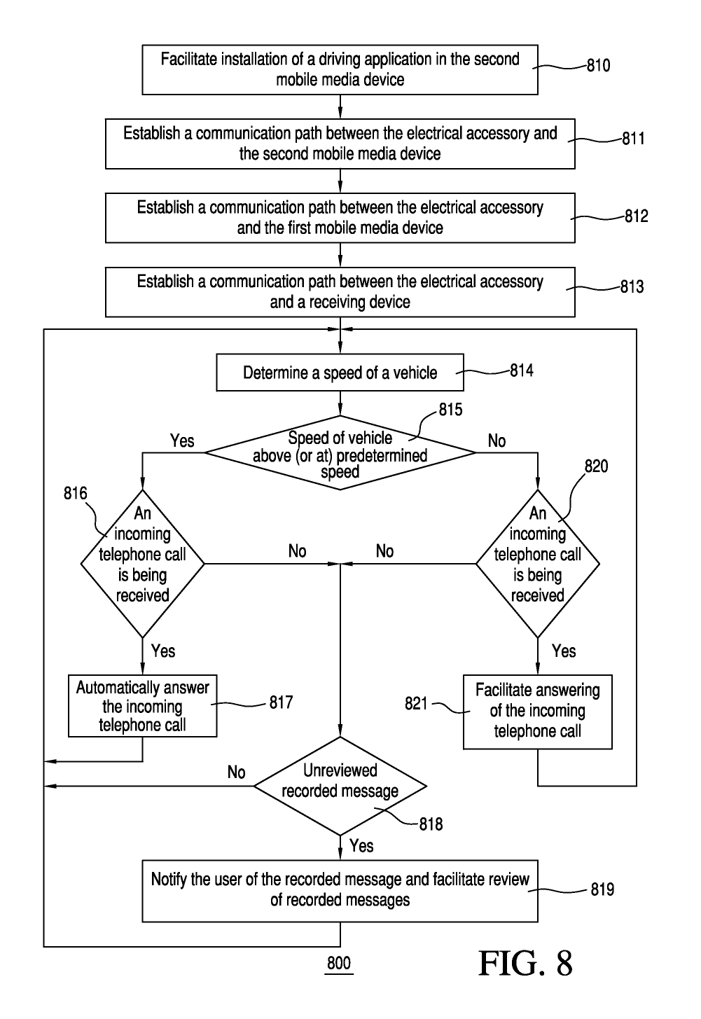

FIG. 8 illustrates a flow chart for an embodiment of a method 800 of processing an incoming telephone call from a first caller, according to a second embodiment. One of the leading causes of traffic accidents and fatalities is drivers talking on their cellular telephone while driving. In some examples, method 800 provides a safer method to handle incoming telephone calls when a user of a cellular telephone is driving a vehicle.

Method 800 is merely exemplary and is not limited to the embodiments presented herein. Method 800 can be employed in many different embodiments or examples not specifically depicted or described herein. In some embodiments, the activities, the procedures, and/or the processes of method 800 can be performed in the order presented. In other embodiments, the activities, the procedures, and/or the processes of the method 800 can be performed in any other suitable order. In still other embodiments, one or more of the activities, the procedures, and/or the processes in method 800 can be combined or skipped.

Referring to FIG. 8, method 800 includes an activity 810 of facilitating installation of a driving module in the second mobile media device. In some examples, activity 810 can be similar to or the same as activity 410 of FIG. 4 of facilitating installation of a dialer module, except in activity 810 a driving module, and not a dialer module, is being installed. The driving module can be similar or the same as driving module 272 (FIG. 2).

Subsequently, method 800 of FIG. 8 includes an activity 811 of establishing a communication path between the electrical accessory and the second mobile media device. In some examples, activity 811 can be similar to or the same as activity 411 of FIG. 4.

Next, method 800 of FIG. 8 includes an activity 812 of establishing a communication path between the electrical accessory and the first mobile media device. In some examples, activity 812 can be similar to or the same as activity 412 of FIG. 4.

Method 800 in FIG. 8 continues with an activity 813 of establishing a communication path between the electrical accessory and a receiving device. In some examples, activity 813 can be similar to or the same as activity 413 of FIG. 4.

Subsequently, method 800 of FIG. 8 includes an activity 814 of determining a speed of a vehicle. In some examples, the electrical accessory, the first mobile media device, the second mobile media device, and the receiving device can be located in a vehicle.

In various embodiments, at least one of the electrical accessory, the first mobile media device, or the second mobile media device can include a GPS (Global Positioning Satellite) receiver. The GPS receiver can be used to determine the speed of the vehicle when the vehicle is moving and the GPS receiver is located within the vehicle.

In some examples, the GPS receiver can be used to determine a first location of the vehicle at a first time and to determine a second location of the vehicle at a second time. In various embodiments, the speed of the vehicle can be determined using at least the first location, the first time, the second location, and the second time.

In some embodiments, if the first mobile media device includes a GPS receiver, the driving module of the second mobile media device or the electrical accessory can communicate a request to a first mobile media device for vehicle speed data and receive the vehicle speed data using the electrical accessory. The vehicle speed data can include the speed of the vehicle as calculated by the first mobile media device. In other examples, the vehicle speed data can include the first location, the first time, the second location, and the second time, and either the driving module or the electrical accessory can calculate the speed of the vehicle.

In another example where the second mobile media device includes the GPS receiver, the driving module can get the vehicle speed data from the GPS receiver and calculate the speed of the vehicle. In yet another example where the electrical accessory includes the GPS receiver, the driving module can get the vehicle speed data from the electrical accessory and calculate the speed of the vehicle.

Next, method 800 of FIG. 8 includes an activity 815 of determining if the speed of the vehicle is above (or at) a predetermined speed. In some examples, if the speed of the vehicle is above a predetermined speed (e.g. 1, 2, or 5 kilometers per hour), the vehicle can be considered to be moving. If the vehicle is moving, the next activity is activity 816. If the vehicle is stationary (i.e., the speed of the vehicle is below the predetermined speed), the next activity is activity 820.

Method 800 in FIG. 8 continues with an activity 816 of determining whether an incoming telephone call is being received. In some examples, determining whether an incoming telephone call is being received can include receiving notification of the incoming telephone call in the electrical accessory or the driving module (via the electrical accessory) from the first mobile media device. If an incoming telephone call is not being received, the next activity is activity 818. If an incoming telephone call is being received, the next activity is an activity 817.

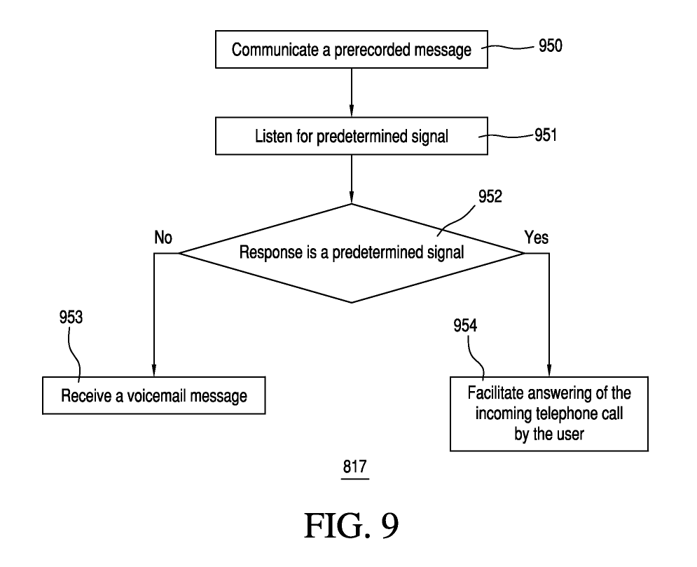

Method 800 of FIG. 8 includes an activity 817 of automatically answering the incoming telephone call. In some examples, the electrical accessory and/or the driving module can automatically answer the incoming telephone call if the speed of the vehicle is above the predetermined speed. FIG. 9 illustrates a flow chart for an embodiment of activity 818 of automatically answering the incoming telephone call, according to the second embodiment.

Referring to FIG. 9, activity 817 includes a procedure 950 of communicating (e.g., playing) a prerecorded message to the caller after automatically answering the incoming telephone. In some examples, procedure 950 includes communicating a prerecorded message from the electrical accessory to a cellular telephone of the first mobile media device. The purpose of communicating the prerecorded message to the caller is to inform the caller that the user of the first mobile media device is unavailable and the telephone call is being transferred to voicemail because the user is driving a moving vehicle. In addition, in some embodiments, the prerecorded messages can give the incoming caller the option to be connected to the user or be connected to voicemail. For example, the prerecorded message can tell the incoming caller that if there is an emergency or if the caller needs to be immediately connected to the user, the caller can press a predetermined button to be connected to the user. In one example, the prerecord message can be “the person you are calling is driving. Press 1 to continue the call; press 2 to leave a voicemail.”

Next, activity 817 of FIG. 9 includes a procedure 951 of listening for a predetermined signal. In some examples, electrical accessory 101 (FIG. 1) or dialer module 271 (FIG. 2) can listen for a predetermined signal from the incoming caller regarding how the incoming caller wants to proceed. In the example above, if the user presses the “one” button or the “two” button, the caller's telephone communicates a standardized signal (e.g., a specific tone) to indicate the caller pressed the “one” or “two” button.

Activity 817 in FIG. 8 continues with a procedure 952 of determining if the response is a predetermined signal. If the incoming signal indicates that the incoming caller wants to leave a voicemail or that the response is not a predetermined signal, the next procedure is a procedure 953. If the incoming signal indicates that the incoming caller wants to be connected to the user, the next procedure is a procedure 954. Electrical accessory 101 (FIG. 1) or dialer module 271 (FIG. 2) can detect the received signal and determine how to proceed.

Subsequently, activity 817 of FIG. 9 includes procedure 953 of receiving a voicemail message (i.e., a response to the prerecorded message). For example, one of electrical device 180 (FIG. 1) or electrical accessory 101 (FIG. 1) can receive a first audio from the cellular telephone of electrical device 190 (FIG. 1) and record/store the first audio.

Activity 817 of FIG. 9 includes procedure 954 of facilitating answering of the incoming telephone call by the user. In some examples, procedure 954 can be similar to or the same as procedures 555-558 of FIG. 5. After procedure 954 or 953, activity 817 is complete.

Referring again to FIG. 8, method 800 of FIG. 8 includes an activity 818 of determining if any unreviewed recorded messages exist. If any recorded messages exist, the next activity is activity 819. If no unreviewed recorded messages exist, the next activity is activity 815.

If unreviewed recorded messages exist, method 800 in FIG. 8 continues with an activity 819 of notifying the user of the recorded message and facilitating review of recorded messages. In some examples, the driving module can only display a message in a display of electrical device 190 or electrical accessory 101 informing the user that unreviewed recorded messages exist if the speed of the vehicle is below the predetermined speed. For example, a message can be shown on display 266 (FIG. 2) informing the user of the unreviewed recorded messages.

If it is determined in activity 815 that the speed of the vehicle is below the predetermined speed, method 800 in FIG. 8 continues with an activity 820 of determining whether an incoming telephone call is being received. In various embodiments, the notification of the incoming telephone call can be received from the first mobile media device by either the electrical accessory or the second mobile media device. In some examples, activity 820 can be similar to or the same as activity 816 of FIG. 8. If an incoming telephone call is not being received, the next activity is activity 818. If a telephone call is being received, the next activity is an activity 821.

Subsequently, method 800 of FIG. 8 includes an activity 821 of facilitating answering of the incoming telephone call. In some examples, activity 821 can be similar to or the same as procedures 555-558 of FIG. 5. After activity 821, the next activity is activity 814.

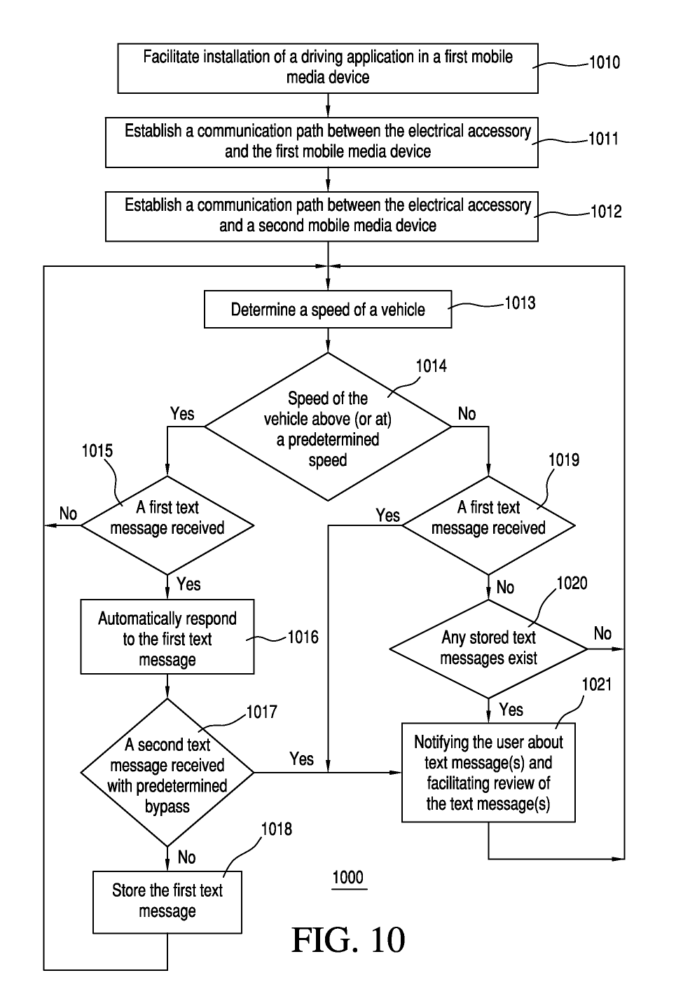

FIG. 10 illustrates a flow chart for an embodiment of a method 1000 of processing an incoming text message from a first sender (or texter) of text messages, according to a third embodiment. One of the leading and growing causes of traffic accidents and fatalities is drivers' texting on their cellular telephone or smart phones while driving. In some examples, method 1000 can provide a safe method to handle incoming text messages when a user of a mobile media device is operating a vehicle.

Method 1000 is merely exemplary and is not limited to the embodiments presented herein. Method 1000 can be employed in many different embodiments or examples not specifically depicted or described herein. In some embodiments, the activities, the procedures, and/or the processes of method 1000 can be performed in the order presented. In other embodiments, the activities, the procedures, and/or the processes of the method 1000 can be performed in any other suitable order. In still other embodiments, one or more of the activities, the procedures, and/or the processes in method 1000 can be combined or skipped.

“Texting,” “text messaging,” or variations thereof, as used herein, refers to the electronic exchange of brief written messages between fixed-line phones, computers, mobile media devices and other fixed-line phones, computers, or mobile media devices over a network. In some examples, “texting,” or “text messaging,” can refer to the Short Messaging Service (“SMS”) provided by telephone carriers. SMS is a text communication service component of phone, web, or mobile communication systems, using standardized communications protocols that allow the exchange of short text messages between fixed line devices and/or mobile devices. In some examples, each text message can be limited to 160 alphanumeric characters.

Referring to FIG. 10, method 1000 includes an activity 1010 of facilitating installation of a driving module in a first mobile media device. In some examples, activity 1010 can be similar to or the same as activity 410 of FIG. 4 of facilitating installation of a dialer module, except in activity 1010 a driving module, and not a dialer module, is being installed. The driving module can be similar or the same as driving module 272 (FIG. 2).

Subsequently, method 1000 of FIG. 10 includes an activity 1011 of establishing a communication path between the electrical accessory and the first mobile media device. In some examples, activity 1011 can be similar to or the same as activity 411 of FIG. 4.

Next, method 1000 of FIG. 10 includes an activity 1012 of establishing a communication path between the electrical accessory and a second mobile media device. In some examples, activity 1011 can be similar to or the same as activity 412 of FIG. 4. the first and second mobile media devices of activities 1010, 1011, and 1012 can be the same as or similar to mobile media devices 180 and 190, respectively, or vice versa.

Subsequently, method 1000 of FIG. 10 includes an activity 1013 of determining a speed of a vehicle. In some examples, activity 1013 can be similar to or the same as activity 814 of FIG. 8.

Next, method 1000 of FIG. 10 includes an activity 1014 of determining if a speed of the vehicle is above (or at) a predetermined speed. In some examples, if the speed of the vehicle is above (or at) a predetermined speed (e.g. 1, 2, or 5 kilometers per hour), the vehicle can be considered to be moving. If the vehicle is moving, the next activity is activity 1015. If the vehicle is stationary (i.e., the speed of the vehicle is below the predetermined speed), the next activity is activity 1019.

Method 1000 in FIG. 10 continues with activity 1015 of determining whether a first text message has been received. In some examples, the electrical accessory can receive notification of the first text message from the first or second mobile media device. In the same or different embodiments, the electrical accessory can communicate the notification to the driving module running on the first mobile media device.

In other examples, determining whether the first text message has been received can include receiving notification of the first text message in the first mobile media device from the second mobile media device, or vice versa. If the first text message has been received, the next activity is activity 1016. If the first text message has not been received, the next activity is activity 1013.

Subsequently, method 1000 of FIG. 10 includes activity 1016 of automatically responding to the first text message. In some examples, driving module 272 (FIG. 2) or electrical accessory 101 (FIG. 1) can send a response to the sender of the first text message. In various embodiments, the automatic responsive text message can inform the sender that the user of the first (and/or second) mobile media device is unavailable, and the text message will not be immediately delivered to the user of the first (and/or second) mobile media device because the user is driving a moving vehicle. In addition, in some embodiments, the automatic responsive text message can provide the sender the option to have the text message delivered immediately instead of stored for later delivery. In various examples, the automatic responsive text message can inform the sender of the first text message that if the sender includes the predetermined bypass indicator in a second text message, the first text message will be immediately delivered to the user. The predetermined bypass indicator can include one or more predetermined characters at the beginning of a text message. In one example, the automatic responsive text message can say, “I'm driving right now, if your text is urgent reply with a 1. Otherwise, I will read it later.”

In other examples, as part of activity 1016, the driving module can also determine if the first text message includes the predetermined bypass indicator. If first text message includes the predetermined bypass indicator, the next activity is activity 1021 of notifying the user of the first (and/or second) mobile media device of the first text message and facilitating review of the text message. For example, if the predetermined bypass indicator can be a “1” as the first character of the text message, the driving module can test if the incoming text message has a “1” as the first character.

In some examples, the driving module can communicate the automatic reply to the cellular telephone of the second mobile media device via the electrical accessory.

Next, method 1000 of FIG. 10 includes an activity 1017 of determining whether a second text message was received from the sender of the first text message with the predetermined bypass indicator. In one example, the predetermined bypass indicator can be a “1” as the first character in a second text message from the first sender. If a second text message with the predetermined bypass indicator is not received, the next activity is activity 1018. If a second text message with the predetermined bypass indicator is received, the next activity is activity 1021 of notifying the user of the first (or second) mobile media device of the first text message and facilitating review of the first text message.

If the second text message with the predetermined bypass indicator was not received, method 1000 in FIG. 10 continues with activity 1018 of storing the first text message. In some examples, the driving module can store the first text message in memory of at least one of the first mobile media device, the second mobile media device, or the electrical accessory. After storing the first text message, the next activity is activity 1015.

If the speed of the vehicle is below the predetermined speed in activity 1013, method 1000 of FIG. 10 includes an activity 1019 of determining whether the first text message has been received. Activity 1019 can be similar to or the same as activity 1015. If the first text message has been received, the next activity is activity 1021. If the first text message has not been received, the next activity is activity 1020.

Next, method 1000 of FIG. 10 includes an activity 1020 of determining whether any stored text messages exist. In some embodiments, as explained above, text messages can be stored in memory while the vehicle is moving and delivered to the user of the first (or second) mobile media device when the vehicle's speed is below the predetermined speed. In activity 1020, the driving module can determine if any text messages are stored in the memory of the first mobile media device, the second mobile media device, and/or the electrical accessory. If no text messages are stored in memory, the next activity is activity 1013. If one or more text messages are stored in memory, the next activity is activity 1021.

Next, method 1000 of FIG. 10 includes an activity 1021 of notifying the user of the first (and/or second) mobile media device of the one or more text messages and facilitating review of the text messages. In some examples, the driving module can notify the user of the text messages and facilitate review of the text messages. For example, the driving module can instruct at least one of the first mobile media device, the second mobile media device, or the electrical accessory to make one or more audible sounds to notify the user of the text messages. In the same or a different example, the driving module can instruct at least one of the first mobile media device, the second mobile media device, or the electrical accessory to display one or more visual indictors or messages to the user that the text messages are awaiting review.

To facilitate review of the text message, the driving module can provide the text message to the user for review on a screen of at least one of the first mobile media device, the second mobile media device, or the electrical accessory. After activity 1023 is complete, the next activity is activity 1013.

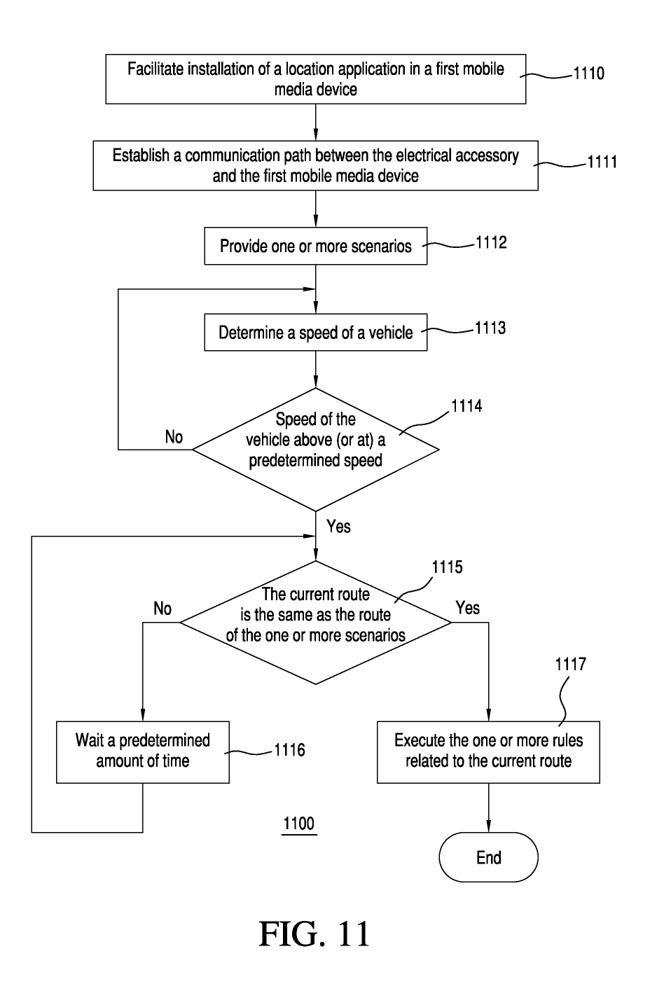

FIG. 11 illustrates a flow chart for an embodiment of a method 1100 of notifying one or more people of an expected time of arrival of a user, according to a fourth embodiment. Method 1100 is merely exemplary and is not limited to the embodiments presented herein. Method 1100 can be employed in many different embodiments or examples not specifically depicted or described herein. In some embodiments, the activities, the procedures, and/or the processes of method 1100 can be performed in the order presented. In other embodiments, the activities, the procedures, and/or the processes of the method 1100 can be performed in any other suitable order. In still other embodiments, one or more of the activities, the procedures, and/or the processes in method 1100 can be combined or skipped.

Not to be taken in a limiting sense, a simple example of method 1100 involves a user using a location module in a first mobile media device to perform one or more actions when the location module determines that the user is traveling a predetermined route in a vehicle. For example, a user of the location module can define scenarios to occur when the user is driving his normal route home from his office. In one embodiment, the location module determines the user is driving home by repeatedly requesting and receiving the current location from a GPS device. After the location module determines the current route of the vehicle, the location module performs one or more rules or predetermined actions for this route. For example, the location module can send a text message, voicemail message, or email to the user's spouse at a specific point along the route letting the spouse know his expected time of arrival at home. In another example, the location module can access the user's schedule for a day using a scheduling module running on the first mobile media device (or the second mobile media device or electrical accessory) and determine that a user might be late for an appointment on the user's schedule. The location module can send a text message, voicemail message, or email to a predetermined person (e.g., a business colleague or assistant) informing him or her that the user will be late for the scheduled appointment.

In a different embodiment, method 1100 in FIG. 11 can be combined with method 800 of FIG. 8 and/or method 1000 of FIG. 10 to notify the person making the telephone call or sending the text message the approximate time when the user or driver is expected to arrive at the destination and receive the voicemail or text.

Referring to FIG. 11, method 1100 includes an activity 1110 of facilitating installation of a location module in a first mobile media device. In some examples, activity 1110 can be similar to or the same as activity 410 of FIG. 4 of facilitating installation of a dialer module, except in activity 1110 a location module, rather than a dialer module, is being installed. The location module can be similar to or the same as location module 273 (FIG. 2). The first mobile media device can be similar to or the same as mobile media device 190 (FIG. 1).

Next, method 1100 of FIG. 11 includes an activity 1111 of establishing a communication path between the electrical accessory and the first mobile media device. In some examples, activity 1111 can be similar to or the same as activity 412 of FIG. 4. In other embodiments, the communication path is not established until later in method 1100.

Subsequently, method 1100 of FIG. 11 includes an activity 1112 of providing one or more scenarios. In some examples, a scenario can be a rule or one or more predetermined actions that occur when the location module determines that the first mobile media device is moving along a predetermined route from a departure location to a destination location. That is, the first mobile media device or the location module can store one or more rules related to the one or more first routes. In one example, a user can enter the one or more scenarios into the first mobile media device. In other examples, the user can enter the one or more scenarios in a web page or another module using a computer or other mobile media device, and the one or more scenarios are transferred to the location module running on the first mobile media device.

In still other embodiments, the location module can be configured to record a route while the first mobile media device is moving along the route and associate a rule or one or more actions with the route. For example, a user can start the location module recording a route, and the location module can repeatedly request and receive the current location from a GPS device. Accordingly, the location module can create a map of the route. Before or after recording the route, the user can enter a rule or one or more actions to associate with the route. For example, the user can instruct the location module to send a text message, voicemail message, or email to a predetermined phone number or email address at a specific point along the route with the estimated time of arrival of the user at the end of the route. In some examples, the location module can also use traffic, weather, and other information to determine the estimated time of arrival of the user at the end of the route.

After the one or more scenarios are provided, method 1100 of FIG. 11 includes an activity 1113 of determining a speed of a vehicle. In some examples, activity 1013 can be similar to or the same as activity 814 of FIG. 8.

Next, method 1100 of FIG. 11 includes an activity 1114 of determining if the speed of the vehicle is above (or at) a predetermined speed. In some examples, if the speed of the vehicle is above a predetermined speed (e.g. 1, 2, or 5 kilometers per hour), the vehicle can be considered to be moving. If the vehicle is moving, the next activity is activity 1115. If the vehicle is stationary (i.e., the speed of the vehicle is below the predetermined speed,), the next activity is activity 1113.

If the vehicle is moving, method 1100 of FIG. 11 includes an activity 1115 of determining if the current route is the same as the route of the one or more scenarios. That is, location module can determine if a current route is one of the one or more routes related to the one or more scenarios. In some embodiments, the location module can request and receive the GPS coordinates from a GPS device at two or more different times. The location module can compare the GPS coordinates from the two or more different times to determine if these GPS coordinates are along any of the routes of the one or more scenarios. If the location module determines that the vehicle containing the first mobile media device is traveling along one of the routes of the one or more scenarios, the next activity is an activity 1117.

If the current route is not a route associated with any of the one or more scenarios, the next activity in method 1100 of FIG. 11 is an activity 1116. Activity 1116 of FIG. 11 can include waiting a predetermined amount of time (e.g., one second, ten seconds, thirty seconds, one minute, five minutes, or ten minutes). After waiting the predetermined amount of time, activity 1115 is repeated. In other examples, if the current route is not a route associated with any of the one or more scenarios in activity 1115, method 1100 is complete.

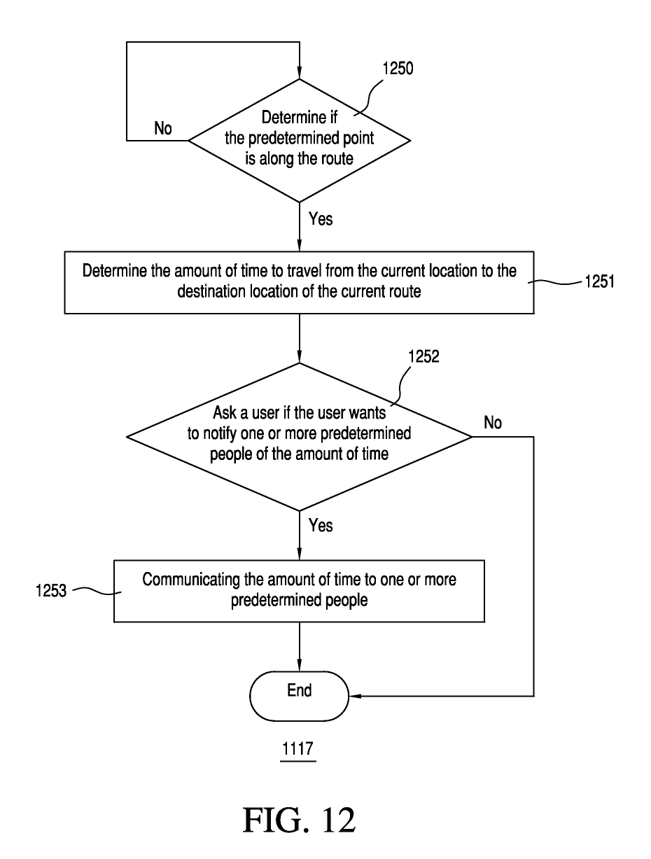

Subsequently, method 1100 of FIG. 11 includes activity 1117 of executing the one or more rules related to the current route. FIG. 12 illustrates a flow chart for an exemplary embodiment of activity 1117 of executing the one or more rules related to the current route, according to the fourth embodiment. In this example, the scenario includes a rule to send a predetermined person (e.g., a spouse) a message at a predetermined point along the route to inform the predetermined person of the expected time of arrival at the destination location of the current route. Activity 1117 can be employed in many different embodiments or examples not specifically depicted or described herein.

Referring to FIG. 12, activity 1117 includes a procedure 1250 of determining whether the vehicle at the predetermined point is along the route. In some examples, if the GPS device is not at the predetermined point along the route, procedure 1250 is repeated until the predetermined point is reached. If the GPS device is at the predetermined point, the next procedure is procedure 1251. In some examples, the predetermined point is a point along the route where the location module performs a predetermined action (i.e., procedure 1253).

Activity 1117 in FIG. 12 continues with procedure 1251 of determining the amount of time to travel from the current location to the destination location of the current route. In some examples, procedure 1251 can include determining an expected arrival time at the destination location. In some examples, the location module can determine the amount of time. In other examples, the location module can communicate the current location and the destination location of the current route to one or more other modules, which calculate the amount of time. In some examples, the one or more other modules are also running on the first mobile media device. In other examples, the location module communicates with the one or more other modules over a network.

Subsequently, activity 1117 of FIG. 11 includes a procedure 1252 asking the user if the user wants to notify one or more predetermined people of the amount of time. In some examples, the location module can make one or more audible noises and present to the user on a screen of the first mobile media device a choice to notify the one or more predetermined people or not. For example, a message could be presented to the user on the screen that states “You will be X minutes late for your appointment. Do you want to notify the meeting organizer via an automated text message?” The user can be presented with a large yes button and a large no button on the screen of the first mobile media device with which the user can make his selection. If the user indicates he wants to notify the one or more predetermined people, the next activity is a procedure 1253. If the user does not want to notify the one or more predetermined people, activity 1117 of FIG. 12 and method 1100 of FIG. 11 are complete until the user begins driving again.

In other examples, the location module does not ask the user if the user wants to notify the one or more predetermined people. For example, the rules from the route could specify to automatically notify the one or more predetermined people and not ask the user. In these examples, procedure 1252 is skipped.

Next, activity 1117 of FIG. 12 includes a procedure 1253 of communicating the amount of time to one or more predetermined people. In some examples, communicating the amount of time can include communicating the expected arrival time at the destination location. In many embodiments, a text message, a voicemail message, and/or an email message can be sent to the one or more predetermined people. After procedure 1253, activity 1117 of FIG. 12 and method 1100 of FIG. 11 are complete until the user begins driving again.

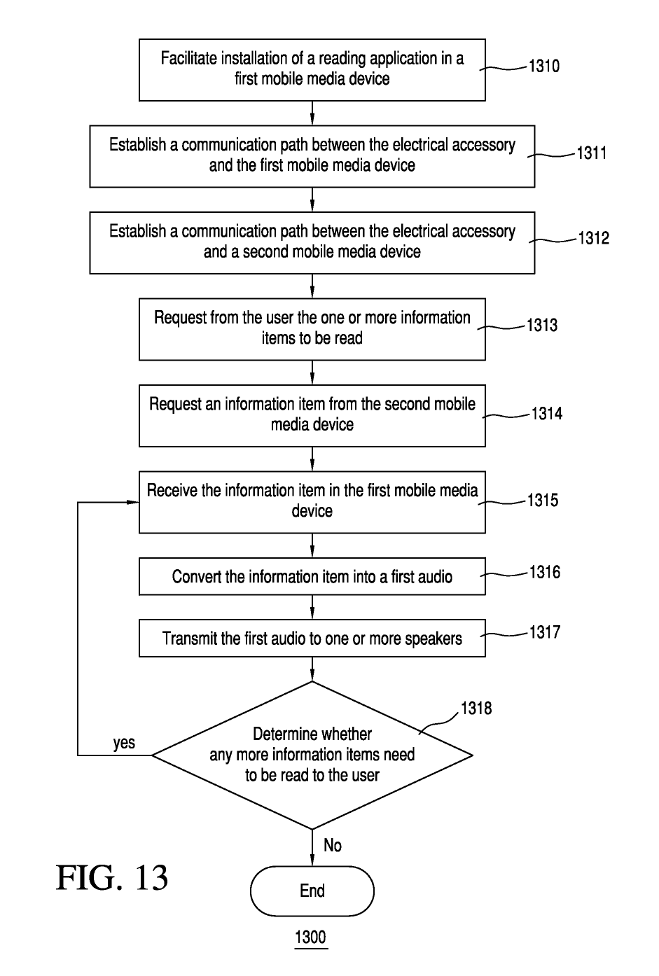

FIG. 13 illustrates a flow chart for an embodiment of a method 1300 of advising a user of an electrical accessory of one or more information items, according to a fifth embodiment. Method 1300 is merely exemplary and is not limited to the embodiments presented herein. Method 1300 can be employed in many different embodiments or examples not specifically depicted or described herein. In some embodiments, the activities, the procedures, and/or the processes of method 1300 can be performed in the order presented. In other embodiments, the activities, the procedures, and/or the processes of the method 1300 can be performed in any other suitable order. In still other embodiments, one or more of the activities, the procedures, and/or the processes in method 1300 can be combined or skipped.

Not to be taken in a limiting sense, a simple example of method 1300 involves a user starting a reading module on the first mobile media device. The first mobile media device communicates with a second mobile media device via an electrical accessory. The reading module requests and receives one or more information items from the second mobile media device via the electrical accessory. The reading module converts the text of the one or more information items into audio and sends the audio to the vehicle's speakers via the electrical accessory. In one example, the one or more information items can include the user's schedule (e.g., items on his electronic calendar) for the day. That is, the reading module can request the user's schedule for the day from the second mobile media device, and the reading module can read the calendar to the user via the speakers in the vehicle. In another example, the reading module can read the user one or more websites, for example, an online news website.

Referring to FIG. 13, method 1300 includes an activity 1310 of facilitating installation of a reading module in a first mobile media device. In some examples, activity 1310 can be similar to or the same as activity 410 of FIG. 4 of facilitating installation of a dialer module, except in activity 1310, a reading module, rather than a dialer module, is being installed. The reading module can be similar to or the same as reading module 274 (FIG. 2), and the first mobile media device can be similar to or the same as mobile media device 190 (FIG. 1).

Subsequently, method 1300 of FIG. 13 includes an activity 1311 of establishing a communication path between the electrical accessory and the first mobile media device. In some examples, activity 1311 can be similar to or the same as activity 411 of FIG. 4.

Next, method 1300 of FIG. 13 includes an activity 1312 of establishing a communication path between the electrical accessory and a second mobile media device. In some examples, activity 1312 can be similar to or the same as activity 413 of FIG. 4, and the second mobile media device can be similar to or the same as mobile media device 180 (FIG. 1).

Subsequently, method 1300 of FIG. 13 includes an activity 1313 of requesting from the user the one or more information items to be read. In some examples, the user can indicate to the reading module what items that user wants the reading module to request. For example, the user can click one or more buttons on a screen of the first mobile media device to specify the information items. In another example, the first mobile media device or the electrical accessory can have a microphone, and the user can verbally request the reading of specific informational items.

Method 1300 in FIG. 13 continues with an activity 1314 of requesting an information item from the second mobile media device. After the reading module has received the list of information items from the user, the reading module can request the one or more informational items from the second mobile media device, via the electrical accessory.

Subsequently, method 1300 of FIG. 13 includes an activity 1315 of receiving the information item in the first mobile media device. In some examples, the first mobile media device can receive the first information item from the second mobile media device, via the electrical accessory.

Next, method 1300 of FIG. 13 includes an activity 1316 of converting the information item into a first audio. In some examples, the reading module can convert the first information item into audio.

Method 1300 in FIG. 13 continues with an activity 1317 of transmitting the first audio to one or more speakers. In some examples, the audio can be transmitted to the speakers via an audio system. The speakers and the audio system can be similar to or the same as speakers 196 and receiving device 195 of FIG. 1.

Subsequently, method 1300 of FIG. 13 includes an activity 1318 of determining whether any more information items need to be read to the user. If one or more additional information items exist that need read to the user, the next activity is activity 1315. If no more information items need read to the user, method 1300 is complete.

Although the invention has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that activities 411-420 of FIG. 4, activities 810-819 of FIG. 8, activities 1010-1021 of FIG. 10, activities 1110-1117 of FIG. 17, activities 1310-1318 of FIG. 13, procedures 550-558 of FIG. 5, procedures 650-652 of FIG. 6, procedures 750-753 of FIG. 7, procedures 950-954 of FIG. 9, and procedures 1250-1253 may be comprised of many different activities, procedures and be performed by many different modules, in many different orders, that any element of FIG. 1 may be modified, and that the foregoing discussion of certain of these embodiments does not necessarily represent a complete description of all possible embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A method of processing an incoming telephone call, the method comprising:
receiving notification of the incoming telephone call using a cellular telephone, the incoming telephone call is from a first caller, and the cellular telephone is located in the vehicle;
determining a speed of a vehicle;
if the speed of the vehicle is below a predetermined speed, facilitating answering of the incoming telephone call by a user, the user is located in the vehicle; and
if the speed of the vehicle is above the predetermined speed, automatically answering the incoming telephone call, automatically answering the incoming telephone call comprises:
transmitting a predetermined message for the first caller;
receiving a response to the predetermined message; and
notifying the user of the response to the predetermined message.

2. The method of claim 1, wherein:
determining the speed of the vehicle comprises:
communicating a request to a first mobile media device for vehicle speed data; and
receiving the vehicle speed data using an electrical accessory, the vehicle speed data comprises the speed of the vehicle.

3. The method of claim 1, wherein:
determining the speed of the vehicle comprises:
determining a first location of the vehicle at a first time using a GPS receiver;
determining a second location of the vehicle at a second time using the GPS receiver; and
determining the speed of the vehicle using at least the first location, the first time, the second location, and the second time; and
the GPS receiver is located at the vehicle and is a part of the cellular telephone or an electronic accessory.

4. The method of claim 1, further comprising:
establishing a communication path between a first mobile media device and an electrical accessory, the first mobile media device comprises the cellular telephone, wherein:
receiving the notification of the incoming telephone call comprises:
receiving the notification of the incoming telephone call in the electrical accessory from the first mobile media device;
facilitating answering of the incoming telephone call comprises:
using the electrical accessory to facilitate answering of the incoming telephone call by the user if the speed of the vehicle is below the predetermined speed; and
automatically answering the incoming telephone call comprises:
using the electrical accessory to facilitate automatically answering the incoming telephone call if the speed of the vehicle is above the predetermined speed.

5. The method of claim 1, further comprising:
establishing a communication path between a first mobile media device and an electrical accessory, the first mobile media device comprises the cellular telephone, wherein:
playing the predetermined message to the first caller comprises:
communicating the predetermined message from the electrical accessory to the cellular telephone of the first mobile media device.

6. The method of claim 1, wherein:
receiving the response to the predetermined message comprises:
listening for a predetermined tone;
receiving a voicemail message from the first caller if the predetermined tone is not heard; and
facilitating answering of the incoming telephone call by the user if the predetermined tone is heard.

7. The method of claim 6, wherein:
notifying the user of the response to the predetermined message comprises:
notifying the user of the incoming telephone call if the predetermined tone is heard; and
notifying the user of the voicemail message from the first caller if the predetermined tone was not heard and after the speed of the vehicle is below the predetermined speed.

8. The method of claim 6, further comprising:
establishing a first communication path between a first mobile media device and a second mobile media device, the first mobile media device comprises the cellular telephone, wherein:
listening for the predetermined tone comprises:
receiving first audio from the cellular telephone of the first mobile media device in the second mobile media device;
determining in the second mobile media device if the first audio comprises the predetermined tone;
receiving the voicemail message comprises:
receiving second audio from the cellular telephone of the first mobile media device in the second mobile media device; and
recording in the second mobile media device the second audio as the voicemail message; and
notifying the user of the response to the predetermined message comprises:
notifying the user of the response to the predetermined message using the second mobile media device after the speed of the vehicle is below the predetermined speed.

9. The method of claim 8, wherein:
establishing the first communication path comprises:
establishing a second communication path between the first mobile media device and an electrical accessory; and
establishing a third communication path between the electrical accessory and the second mobile media device.

10. A method of processing two or more incoming text messages, the method comprising:
receiving a first incoming text message of the two or more incoming text messages from a first sender;
determining a speed of a vehicle;
if the speed of the vehicle is below a predetermined speed, facilitating notification of a user of the first incoming text message of the two or more incoming text messages, the user is located in the vehicle;
if the speed of the vehicle is above the predetermined speed, facilitating sending an automatic reply to the first incoming text message of the two or more incoming text messages;
after facilitating sending the automatic reply, receiving a second incoming text message of the two or more incoming text messages;
if the second incoming text message of the two or more incoming text messages is received from the first sender and the second incoming text message of the two or more incoming text messages includes a predetermined bypass indicator, facilitating notification of the user of the first incoming text message of the two or more incoming text messages; and
if the user has not previously been notified of the first incoming text message of the two or more incoming text messages, facilitating notification of the user of the first incoming text message of the two or more incoming text messages when the speed of the vehicle is below the predetermined speed.

11. The method of claim 10, wherein:
determining the speed of the vehicle comprises:
communicating a request to a first mobile media device for vehicle speed data; and
receiving the vehicle speed data using an electrical accessory, the vehicle speed data comprises the speed of the vehicle.

12. The method of claim 10, wherein:
determining the speed of the vehicle comprises:
determining a first location of the vehicle at a first time using a GPS receiver;
determining a second location of the vehicle at a second time using the GPS receiver; and
determining the speed of the vehicle using at least the first location, the first time, the second location, and the second time; and
the GPS receiver is located at the vehicle.

13. The method of claim 10, further comprising:
establishing a communication path between a first mobile media device and a second mobile media device,
wherein:
receiving the first incoming text message comprises:
receiving the first incoming text message of the two or more incoming text messages using the first mobile media device;
if the second text message of the two or more incoming text messages is received from the first sender and the second incoming text message of the two or more incoming text messages includes a predetermined bypass indicator, facilitating the notification of the user of the first incoming text message of the two or more incoming text messages comprises:
communicating the first incoming text message of the two or more incoming text messages from the first mobile media device to the second mobile media device;
determining in the second mobile media device if the second incoming text message of the two or more incoming text messages includes the predetermined bypass indicator;
determining in the second mobile media device if the second incoming text message of the two or more incoming text messages is from the first sender; and
if the second incoming text message of the two or more incoming text messages is received from the first sender and the second incoming text message of the two or more incoming text messages includes the predetermined bypass indicator, notifying the user of the first incoming text message of the two or more incoming text messages using the second mobile media device;
facilitating sending an automatic reply to the first incoming text message comprises:
if the speed of the vehicle is above the predetermined speed, communicating the automatic reply to the first mobile media device from the second mobile media device.

14. The method of claim 13, wherein:
establishing the communication path comprises:
establishing a first communications path between the first mobile media device and an electrical accessory; and
establishing a second communication path between the electrical accessory and the second mobile media device.

15. The method of claim 10, wherein:
the predetermined bypass indicator comprises one or more predetermined characters.

16. A method of notifying one or more people of an expected time of arrival of a user at one or more destination locations, the method comprising:
storing one or more first routes between one or more departure locations and the one or more destination locations;
storing one or more rules related to the one or more first routes;
determining if a current route is one of the one or more first routes;
if the current route is the one of the one or more first routes, executing the one or more rules related to the one of the one or more first routes,
wherein:
executing the one or more rules comprises:
determining a current location of a GPS receiver;
determining an amount of time to travel from the current location to a first destination location of the one or more destination locations; and
communicating information regarding the amount of time to at least one predetermined person; and
the current route is between a first departure location of the one or more departure locations and the first destination location of the one or more destination locations.

17. The method of claim 16, wherein:
executing the one or more rules further comprises:
determining an expected arrival time at the first destination location of the one or more destination locations using the amount of time to travel from the current location to the first destination location of the one or more destination locations;
communicating the information regarding the amount of time comprises:
communicating the expected arrival time to the at least one predetermined person.

18. The method of claim 16, wherein:
executing the one or more rules further comprises:
determining if the user wants to notify the at least one predetermined person about the information regarding the amount of time; and
communicating the information regarding the amount of time comprises:
communicating the information regarding the amount of time to the at least one predetermined person only if instructed by the user to do so.

19. The method of claim 16, wherein:
storing the one or more rules related to the one or more first routes comprises:
storing the one or more rules related to the one or more first routes in a first mobile media device;
determining if the current route is the one of the one or more first routes comprises:
using the first mobile media device to determine if the current route is the one of the one or more first routes; and
executing the one or more rules comprises:
using the first mobile media device to execute the one or more rules related to the one of the one or more first routes if the current route is the one of the one or more first routes.

20. The method of claim 16, wherein:
determining if the current route is the one of the one or more first routes and executing the one or more rules related to the one of the one or more first routes are performed by an electrical device while the electrical device is in a vehicle; and
the vehicle is moving.
